(19) United States
(12) Patent Application Publication
(10) Pub. No.: US 2013/0316703 A1
(43) Pub. Date: Nov. 28, 2013

(54) CHARGING AND BILLING FOR CONTENT, SERVICES, AND ACCESS

(71) Applicant: Aquto Corporation, Boston, MA (US)

(72) Inventors: Nicolas Girard, Boston, MA (US); Yusun Kim Riley, Weston, MA (US)

(73) Assignee: Aquto Corporation, Boston, MA (US)

(21) Appl. No.: 13/893,744

(22) Filed: May 14, 2013

Related U.S. Application Data
(60) Provisional application No. 61/648,802, filed on May 18, 2012.

(51) Int. Cl. G06Q 20/14; G06Q 30/02; G06Q 30/06

(52) U.S. Cl. CPC G06Q 20/145; G06Q 30/0601; G06Q 30/0251
USPC 455/432.1; 705/34; 705/26.1; 705/14.55; 705/14.49; 705/14.64

(57) ABSTRACT

Among other things, at a server, information is received from applications, services, or content being used on user devices about usage of communication services attributable to each of the applications, services, or content. The information about the amounts of attributable communication services is used in allocating charges for the services to one or more paying parties in accordance with one or more applicable business rules.

### CROSS-REFERENCE TO RELATED APPLICATIONS

This application claims priority to U.S. Provisional Application Ser. No. 61/648,802, filed on May 18, 2012, entitled “CHARGING AND BILLING FOR CONTENT, SERVICES, AND ACCESS,” the entire contents of which are hereby incorporated by reference.

### BACKGROUND

This description relates to charging and billing for content, services, and access.

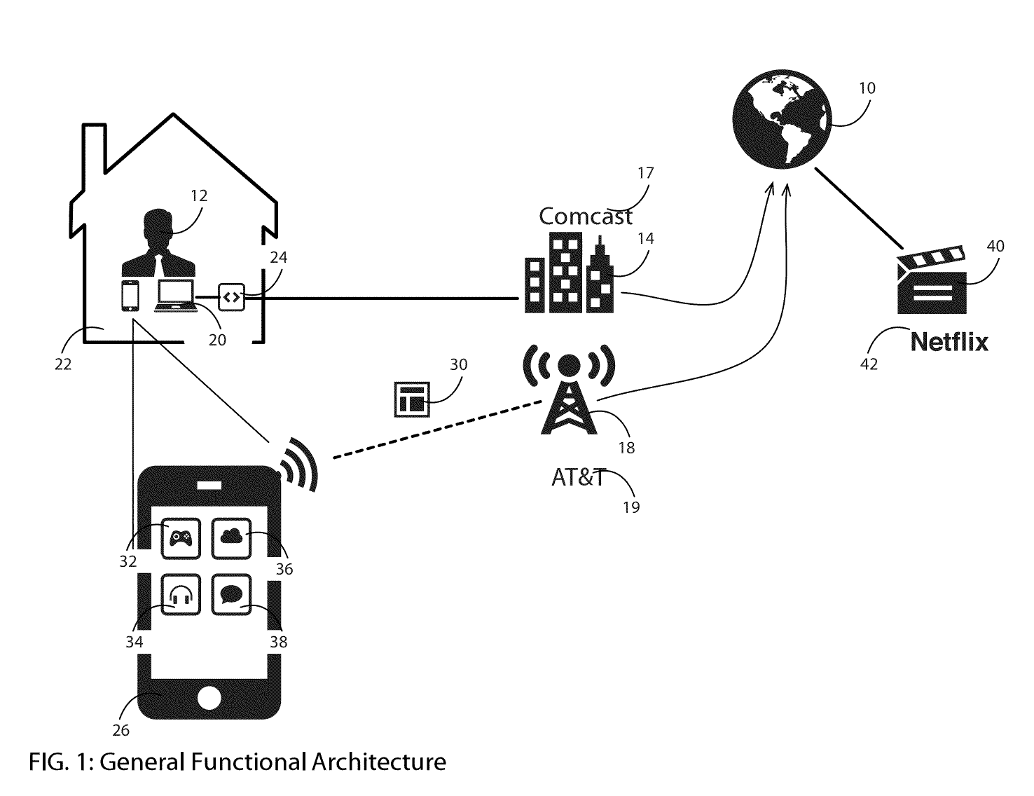

As shown in FIG. 1 in the case of content consumption over the Internet 10, one paradigm for charging and billing is for subscribers 12 to purchase Internet access from a network operator, whether it is wired access 16 (from cable companies 17 such as Comcast or fixed telephony such as Verizon) or wireless access 18 (from companies 19 such as AT&T and Verizon).

Wired access to the Internet is usually tied to a specific device 20 at a specific location 22 (such as a modem 24 in a home or in an office) and sometimes restricted to specific devices attached to that modem. Wireless access, by its nature, cannot be restricted to a specific location so it is typically tied to a device 26, such as a tablet or a smartphone.

Internet access is typically purchased as a subscription to use a certain amount of capacity that is traditionally measured in bytes, over the course of a time period, typically a month; this capacity is often referred to as ‘data bandwidth’, e.g., the capacity to deliver up to a fixed number of bytes over the telecom network (wired or wireless). Subscribers typically purchase a monthly data plan subscription or allotment (for instance 2 GB/month for a mobile device and 100 GB/month for a fixed broadband connection in a home). We sometimes use the terms total bandwidth, capacity, quota, usage, and allotment interchangeably.

Content 30 delivered over the wired or wireless Internet connection is, in most modern networks, distributed using standard TCP/UDP transport protocols and packaged as IP packets forming a session. Each delivered IP packet is expressed in a number of bytes, which counts towards the data bandwidth allotment a subscriber purchases from the network operator.

Subscriber Internet services can have a variety of usage limits. Some services are considered to have an ‘unlimited’ allotment, that is the data usage is theoretically not metered and the subscriber can make use of any amount of content/services without any restrictions. However, in practice, restrictions often exist and policies are put in place to guarantee the continued viability of the Internet service for all users. Typically the throughout, e.g., the speed at which the IP packets carrying the content are delivered, is dynamically throttled by the operator for individual subscribers usage, to mitigate the negative impact unlimited usage can have on the network. Throughput is typically throttled when the subscriber's usage passes some threshold, considered to be excessive, or the network is congested. In both cases, throttling throughput has the negative impact of impairing most modern services.

The majority of mobile Internet services are limited and have quotas associated with them. Mobile data plans have a fixed size; if a subscriber goes over her quota, the Internet connectivity is typically severed (and as a result, application, content, and communication services that use the Internet for delivery stop working) or the subscriber is charged a hefty fee for her over-quota usage.

Separately from purchasing Internet access, subscribers typically purchase services such as applications 32 (e.g., games, software) or content 34 (e.g., music, movies) or subscribe to content-based services 36 (e.g., audio or video streaming, Internet TV, online magazines, online news) or communication services 38 (e.g. voice, messaging, chat, video communication). These applications, content, and services are sometimes offered directly by the same companies 17, 19 offering network access as add-ons or sometimes are purchased from third-party providers 40, such as Netflix 42. It is up to the subscribers to reconcile with any applicable usage quotas the amount of their content consumption across all the services they subscribe to and all the devices they own. As wireless network speeds keep on getting faster than ever (4G LTE speeds can be faster than fixed broadband) and Internet-based content and services are delivered in greater number and higher quality, e.g. require more bandwidth, this model of delivery may be unsustainable.

When applications, content, and services (we sometimes refer to all of them using only one of the words: applications, services, content) are distributed through the Internet, the cost of distribution can be defined as the cost of packaging the content (which can include the cost incurred to encode video for best delivery or to send content onto Internet-based publishing platforms, for instance), the cost of serving the content (which can include the cost of distributing the content through a content delivery network and the marginal cost of delivery through fixed and mobile networks), and the cost of billing for the content distribution (which can include complex multi-party business arrangements among the stakeholders involved in the distribution).

Sometimes content and its distribution are combined for purposes of billing to subscribers. For instance, when subscribing to content represented by television channels delivered through fixed cable networks, subscribers do not pay separately for the cost of distribution of the content. Instead, the price of the subscription includes the cost of distribution and takes account of revenue from the advertising that is also delivered to the subscribers and a profit.

Similarly, when Amazon introduced the first Kindle, its landmark capability was to be able to download any electronic book available in the store, anywhere in the United States, in less than 60 seconds. Kindle buyers did not have to buy a separate cellular data connection subscription to enable that feature. Indeed, Amazon secured an agreement with a national wireless network provider to sell wholesale bandwidth to power the service and included the cost of the wireless distribution as part of the purchase price of the electronic book.

In both cases, a single provider, acting as the distributor and gatekeeper, controlled the value equation and the bundling of content, and distribution was tied and restricted to specific devices (the cable ‘box’ in the case of television and the Kindle eBook reader in the case of Amazon).

### SUMMARY

In general, in an aspect, at a server, information is received from applications, services, or content being used on user devices about usage of communication services attributable to each of the applications, services, or content. The information about the amounts of attributable communication services is used in allocating charges for the services to one or more paying parties in accordance with one or more applicable business rules.

In general, in an aspect, at a user device, a usage of communication service is tracked that is attributable to the use of an application, service, or content on the device. The tracked amount of communication service is sent to a server for use in allocating charges for the services to one or more paying parties in accordance with one or more applicable business rules.

In general, in an aspect, processes running on user devices track usage of communication services attributable to use of applications, services, or content on the devices. An allocation process running on a server uses the tracked usage information in allocating charges for the communication services to paying parties based on one or more applicable business rules.

In general, in an aspect, an executable program stored on a user device, when running on the user device, tracks usage of communication services attributable to applications, services, or content being used on the device. The tracked usage is reported to a server for use in allocating charges for the communication services to paying parties based on one or more applicable business rules.

In general, in an aspect, an executable program stored on a server, when running on the server, receives from user devices, information about usage of communication services attributable to applications, services, or content being used on the devices. Charges for the communication services are allocated to paying parties based on one or more applicable business rules.

Implementations of each of these and other aspects may include one or more of the following features. The tracked usage is expressed at a granularity that can be at least as fine-grained as per application, per service, or per item of content. The devices include mobile devices. The devices include non-mobile devices. The paying parties include at least one of: communication service providers, advertisers, end users, network operators, content delivery network operators, content providers, application providers, or service providers. The tracked usage of communication services includes information about at least one of: time period of use, instances of use, or bandwidth of use. The business rules include rules agreed upon by at least one of the paying parties. The business rules include bundling the charges for communication services with charges for applications, services, or content. The business rules can be changed dynamically without changing processes running on the user devices from which the usage information is received. The tracked usage includes information with respect to at least one of usage, usage limits, or quotas. The usage is tracked by at least one of: a process that is included in a software binary of the application, service, or content; a process executed within a Web browser; or a process running as part of an operating system The method of claim in which tracking of usage can include at least one of the following functions: secure connection, authentication, granular accounting, stamping and recording of each connection initiated by the device to use communication services, offline reporting, or steering of communication traffic.

In general, in an aspect, charges are determined for communication services that are attributable to applications, services, or content used on mobile devices that are subject to communication service agreements between a provider of the communication services and customers. Interaction occurs with a system of the provider of the communication services to cause records associated with the customers to reflect at least portions of the charges that are to be paid by someone other than the customers.

Implementations may include one or more of the following features. The charges are to be paid by the provider of the communication services. The charges are to be paid by a third party. The system of the provider includes a billing system. The interacting with the system of the provider is done using an APN. The interacting with the system of the provider includes use of a special charging APN for the applications, services, or content. The interacting includes providing to the system of the provider charge records that include portions of the communication services usage that are to be billed to the customers, portions that are to be sponsored by the communication services provider, and portions that are to be sponsored by third parties. The communication service providers include mobile operators. The interacting with the system of the provider includes use of a regular APN and a charging API. The interacting with the system of the provider includes use of a regular APN and offline record reconciliation between records that reflect the determined charges and communication service usage recorded by network gateways.

In general, in an aspect, a user device is to receive communication services under a subscription agreement. Applications, services, or content are to be used on the user device for which communication services are to be charged at least in part to someone other than a subscriber under the subscription agreement. Communication for the applications, services, or content is caused to be carried through a special communication gateway that is maintained by a provider of the communication services.

Implementations may include one or more of the following features. The communications are caused to be carried through the special gateway on a per-application, per-service, or per-content item basis. The communications are caused to be carried through the special gateway on a per-flow basis. The gateway is associated with a special access point name (APN). Different APNs are used simultaneously for different applications, services, or items of content, or within a given application, service, or item of content. Causing the communication to be carried through a special communication gateway includes running a process on the user device that selectively sends the communications for the applications, services, or content to the gateway and sends other communications through another communication gateway. The communications are sent to an appropriate gateway using appropriate an appropriate APN. The provider of communication services includes a mobile operator and the device includes a mobile device.

In general, in an aspect, a gateway of a communication service provider is operated to receive specially directed communications from user devices. The specially directed communications are attributable to applications, services, or content for which communication services are to be charged at least in part to someone other than a subscriber of the communication services provider.

Implementations may include one or more of the following features. The gateway is associated with a special access point name (APN). Different APNs are used simultaneously for different applications, services, or items of content, or within a given application, service, or item of content. Charges for the specially directed communications are processed in accordance with agreements of sponsors of the specially directed communications. The provider of communication services includes a mobile operator and the devices include mobile devices. The specially directed communications are received on a per-application, per-service, or per-content item basis. The specially directed communications are received on a per-flow basis.

In general, in an aspect, in connection with the use of a particular application, service, or item of content or a set of applications, services, or items of content at a user device, a user can select a communication service arrangement to be used for that particular application, service, or item of content, or set of applications, services, or items of content.

Implementations may include one or more of the following features. The selection is enabled at the time of initiation of use of the particular application, service, or item of content or set of applications, services, or items of content. The user device includes a mobile device. The communication service arrangement includes one of two or more available service arrangements that have different bandwidth or coverages or both. The service arrangements include cellular telephone network service or Wi-Fi service. The service arrangements include at least one of time-based arrangements, session-based arrangements, or content-based arrangements. The selection is enabled by a process running on the user device. The process is configured to enable the selection based on a predetermined business model.

In general, in an aspect, a mobile device has a subscription agreement that is applicable for a covered area and for which roaming charges apply outside of the covered area. A user of the mobile device can (a) selectively control operation of the mobile device so that roaming charges will not apply to any use of the mobile device, and (b) while the roaming charges are not applied, use one or more individual applications, services, or items of content on the mobile device that require communication services, and have the communication services paid for with respect to the use of the one or more individual applications, services, or items of content.

Implementations may include one or more of the following features. The communication services are paid for by at least one of a provider of the application, service, or item of content, an advertiser, or a developer of the application, service, or item of content. The user is enabled to have the communication services paid for by a process that runs on the mobile device, tracks the communication services that are used, and reports them to a server.

In general, in an aspect, a mobile device is used by a person in at least two different contexts such that the communication service charges for uses in the two different contexts are to be charged to two or more different corresponding parties based on different applications, services, items of content, or traffic flows that are attributable to uses in the different contexts. Communication service usage on the mobile device is tracked for the different applications, services, items of content, or traffic flows, and the tracked usage is used to charge the corresponding parties for usage in the different contexts.

Implementations may include one or more of the following features. The two different contexts include personal activities and work activities. The user is one of the parties to be charged and an employer or other entity with which the user has a relationship is another one of the parties to be charged. There are multiple mobile devices and charges for uses in one of the contexts by the users of the mobile devices are consolidated for billing to an entity with which all of the users have a relationship. The users are all employees of the entity and the contexts are personal use and work use.

In general, in an aspect, a user of a user device can receive value in exchange for permitting an advertising or marketing communication to be presented on the device in connection with the user making use of a particular application, service, or item of content on the user device.

Implementations may include one or more of the following features. The user device includes a mobile device. The value includes a right to use an amount of communication bandwidth. The communication bandwidth value can be redeemed on another user device of the user. The user device and the other user device are provisioned on networks of different communication carriers. The timing of the ability to exchange value or the amount of value to be received vary with an amount of subsidized communication service remaining available for the user. The method of claim including enabling the user to redeem the value in exchange for currency earned through engagement offers of marketers or brand owners. The value includes a right to use a particular item of content in exchange for watching an advertisement.

In general, in an aspect, advertising is delivered to a user device in connection with a use on the device of an application, service, or item of content. The user device is associated with a subscription agreement for communication services. A portion of the communication services that are attributable to the application, service, or item of content is zero-rated with respect to billing under the subscription agreement.

Implementations may include one or more of the following features. The user device includes a mobile device. The zero-rating is arranged on a per-application, per-service, per-item of content or per-traffic flow basis.

In general, in an aspect, information is received about amounts of communication services attributable to respective uses of applications, services, or items of content on two or more user devices that are subject to subscription agreements for communication services with a single party. The information is correlated across the two or more user devices for use in billing under the subscription agreements.

Implementations may include one or more of the following features. The two or more user devices are provisioned on two or more different communication service networks. The user devices include mobile devices.

These and other aspects, features, and implementations, and combinations of them can be expressed as methods, business methods, apparatus, systems, components, means or steps for performing functions, and in other ways.

Other implementations, aspects, features, and advantages will become apparent from the following description, and from the claims.

### DESCRIPTION

FIG. 1 is a general functional architecture of how subscribers access internet-based content.

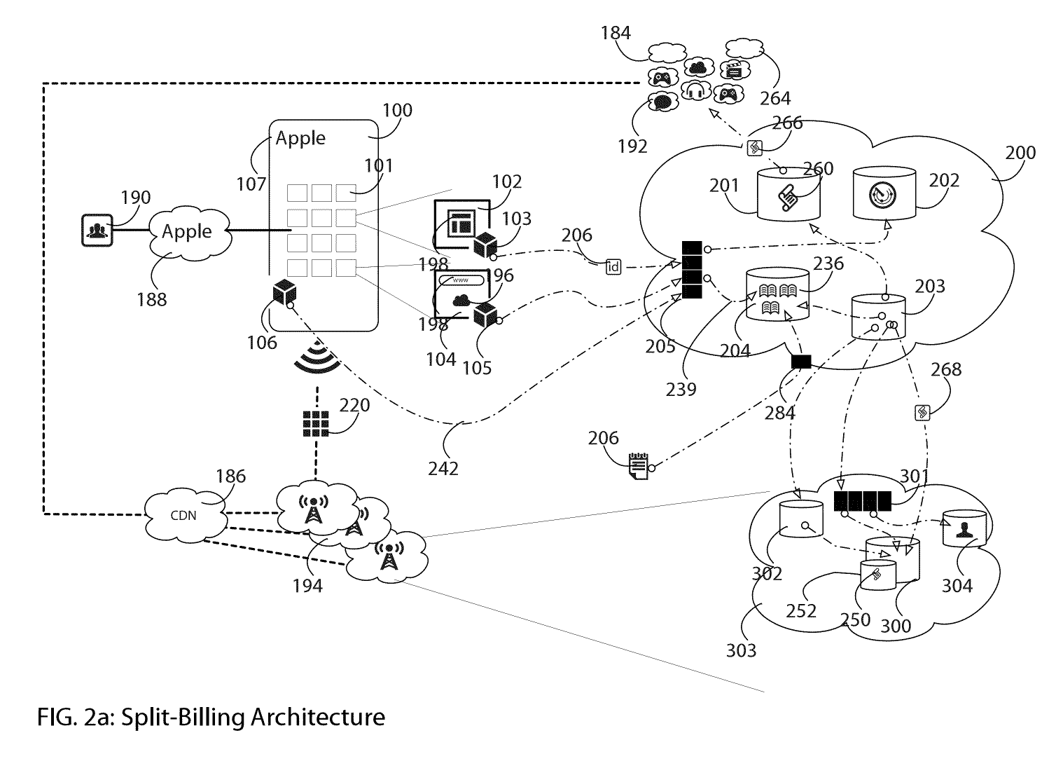

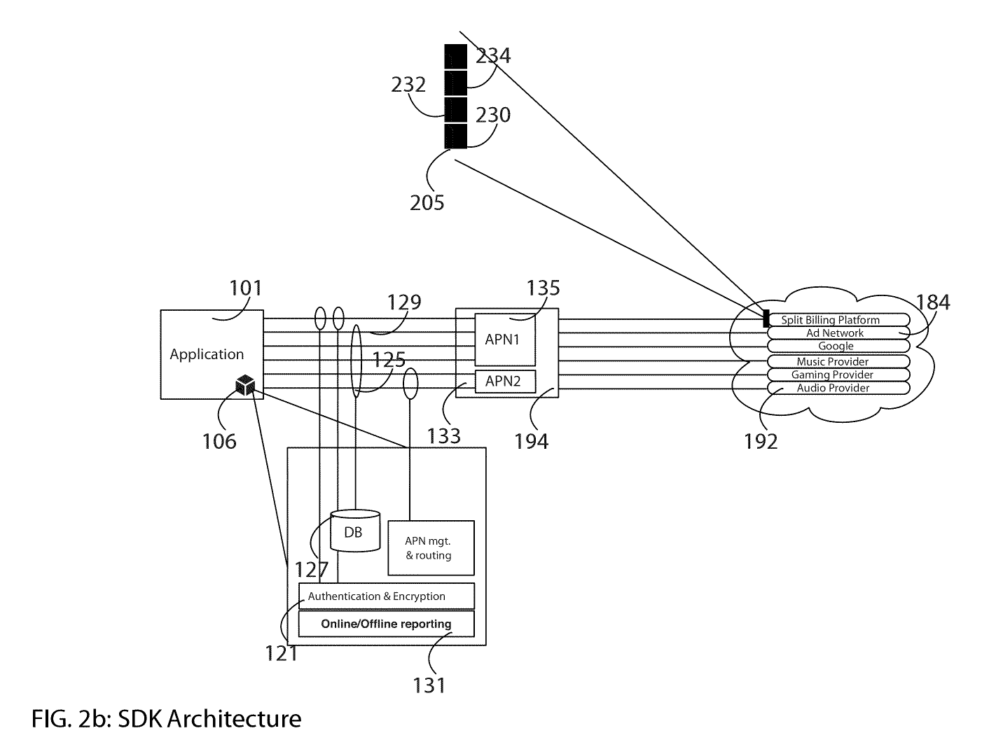

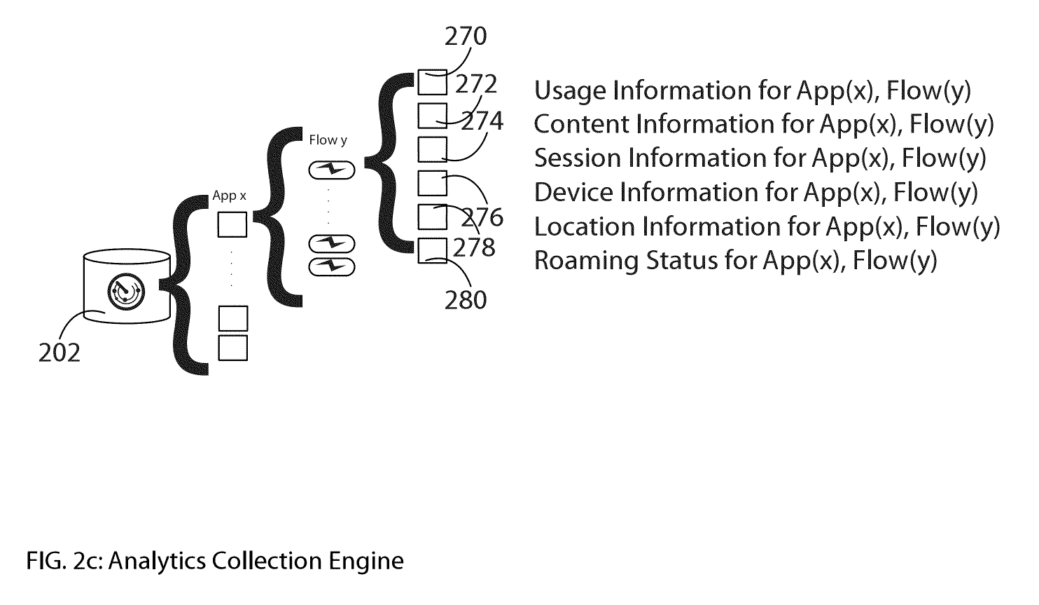

FIG. 2a is a functional diagram describing an architecture of a split-billing platform.

FIG. 2b is a functional diagram describing an architecture of a client SDK.

FIG. 2c is a functional diagram describing an information structure of an analytics collection engine.

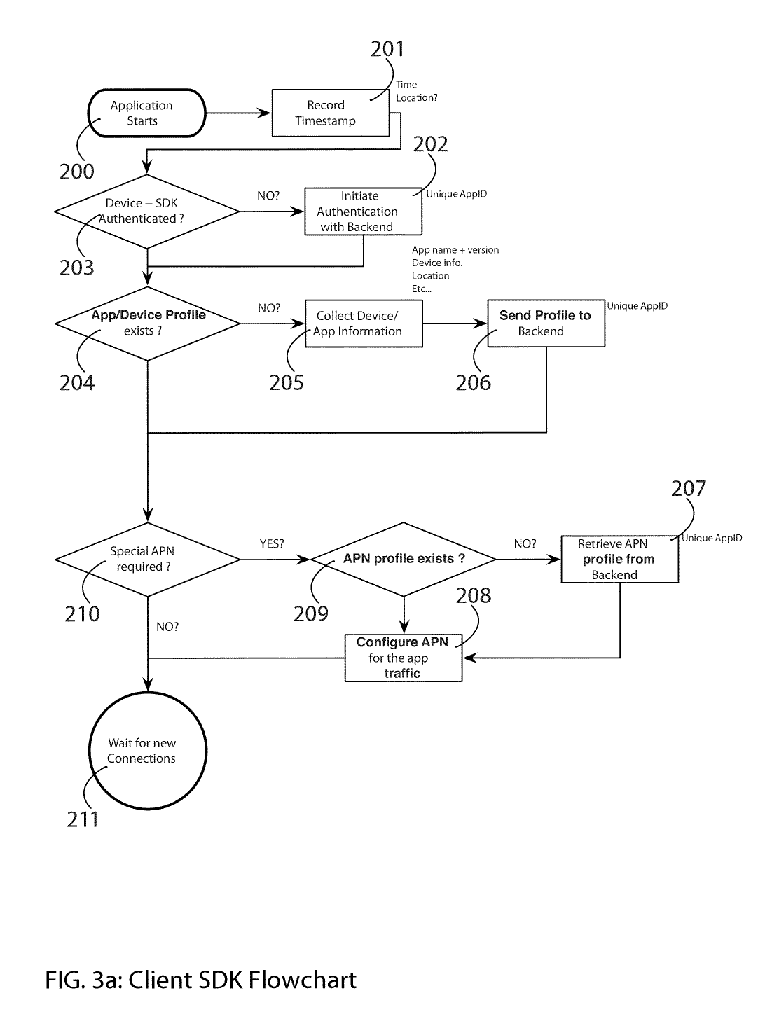

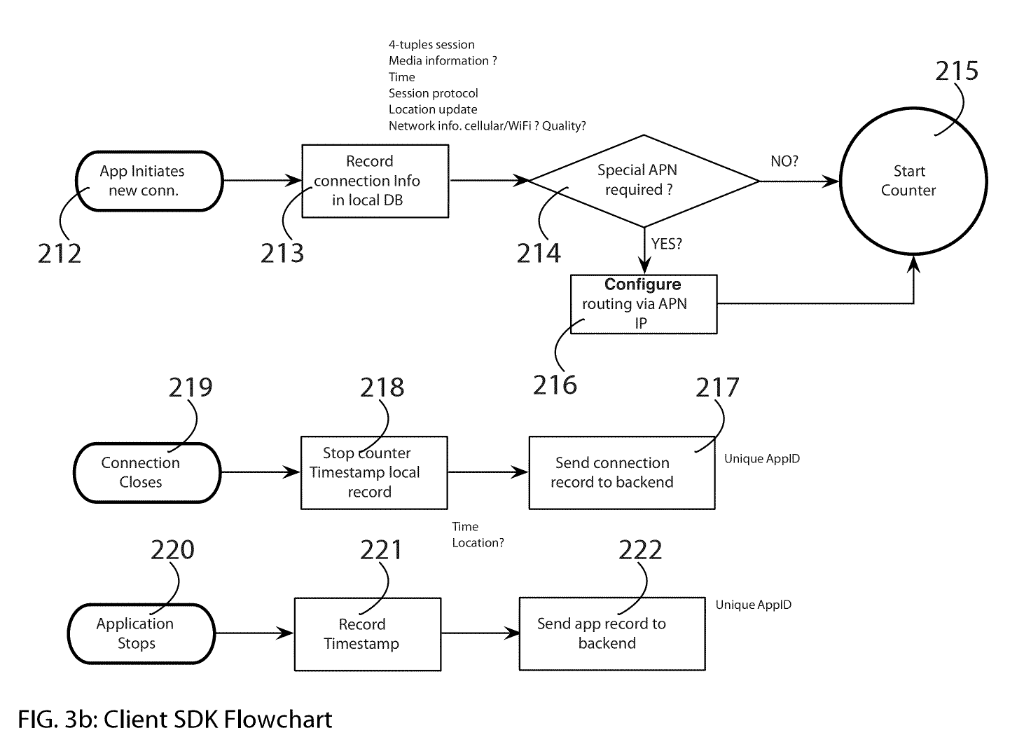

FIG. 3a is a flow diagram of operations performed by the SDK at a launch of a mobile application.

FIG. 3b is a flow diagram of operations performed by the SDK when an application initiates a new data connection, closes a data connection, and stops.

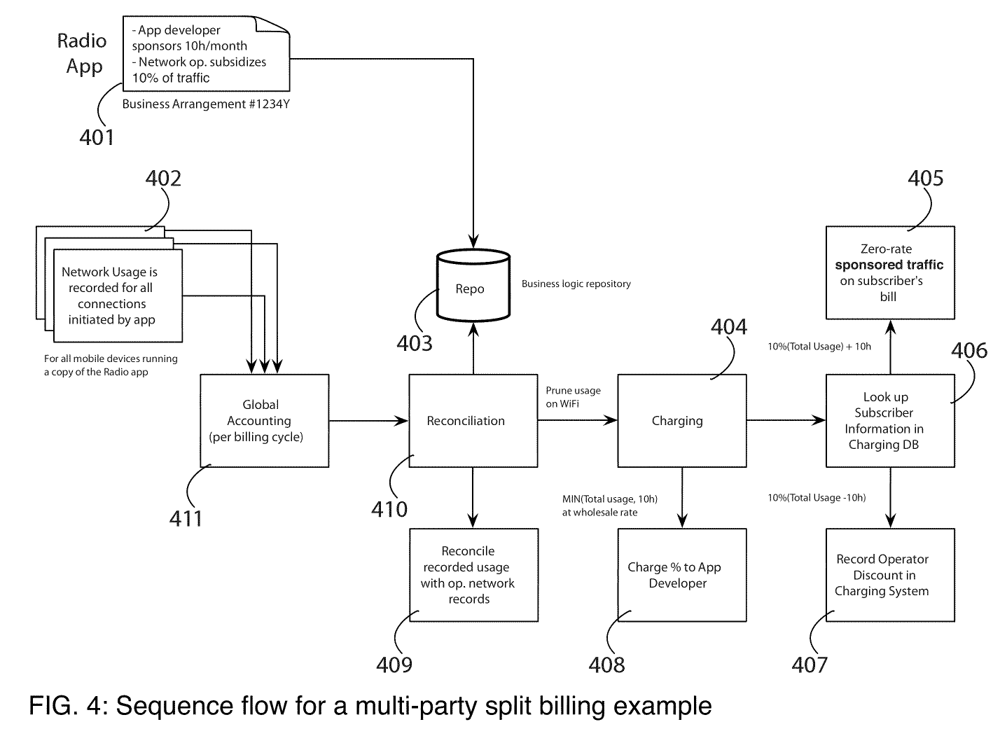

FIG. 4 is a logical sequence flow diagram of a multi-party split billing example.

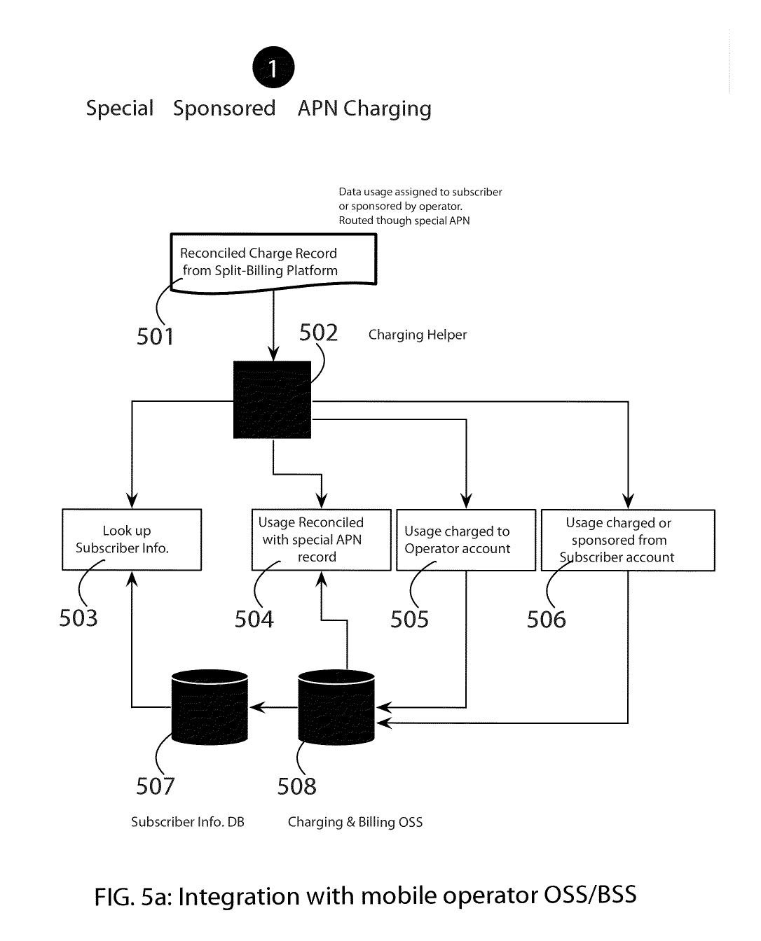

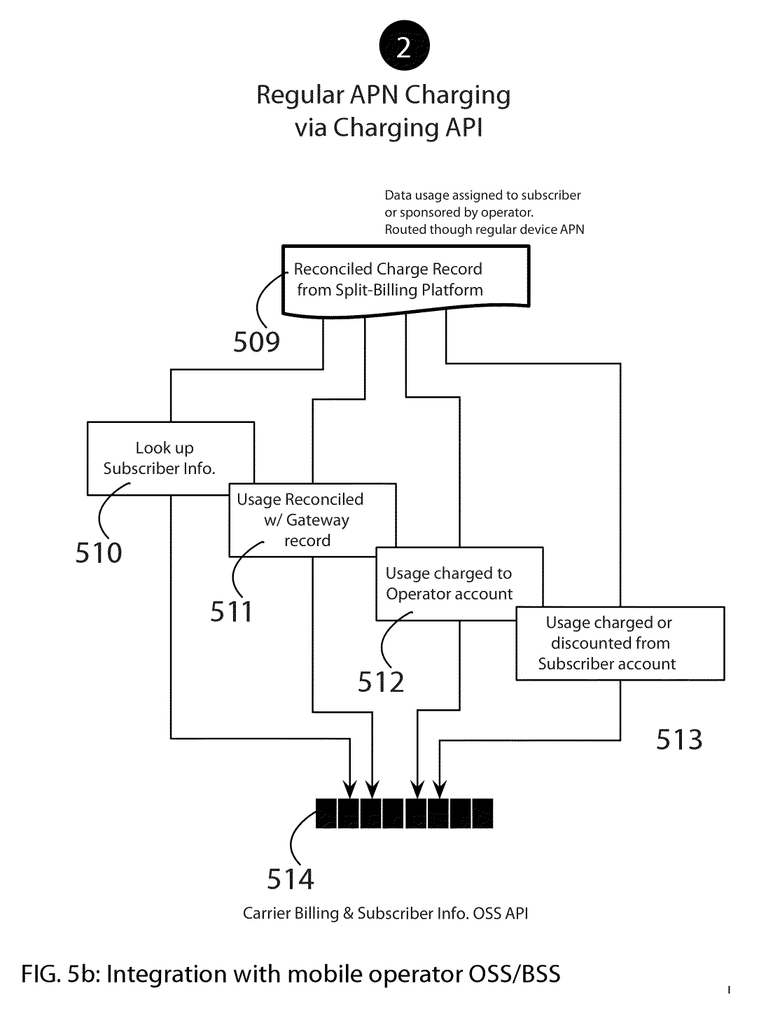

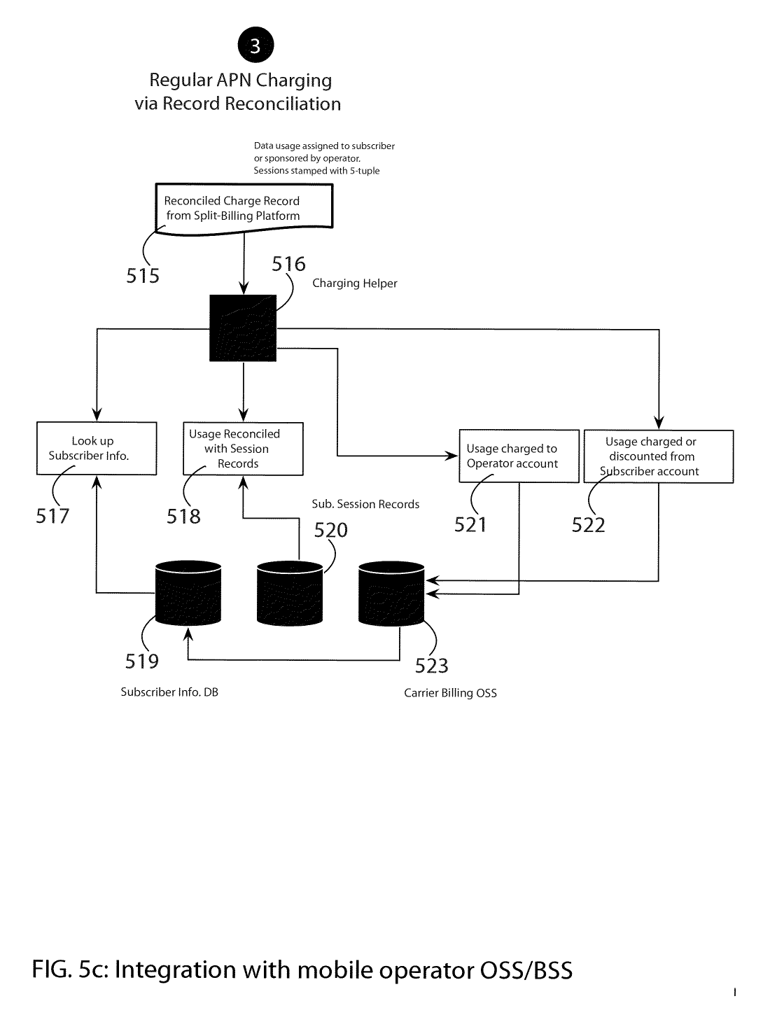

FIG. 5a is logical flow diagram describing an integration with a mobile operator OSS/BSS when a special sponsored APN (Access Point Name) is used for charging.

FIG. 5b is logical flow diagram describing an integration with a mobile operator OSS/BSS when a regular APN is used for charging and a charging API is available to enable split-billing.

FIG. 5c is logical flow diagram describing an integration with a mobile operator OSS/BSS when a regular APN is used for charging and record reconciliation is performed to enable split-billing.

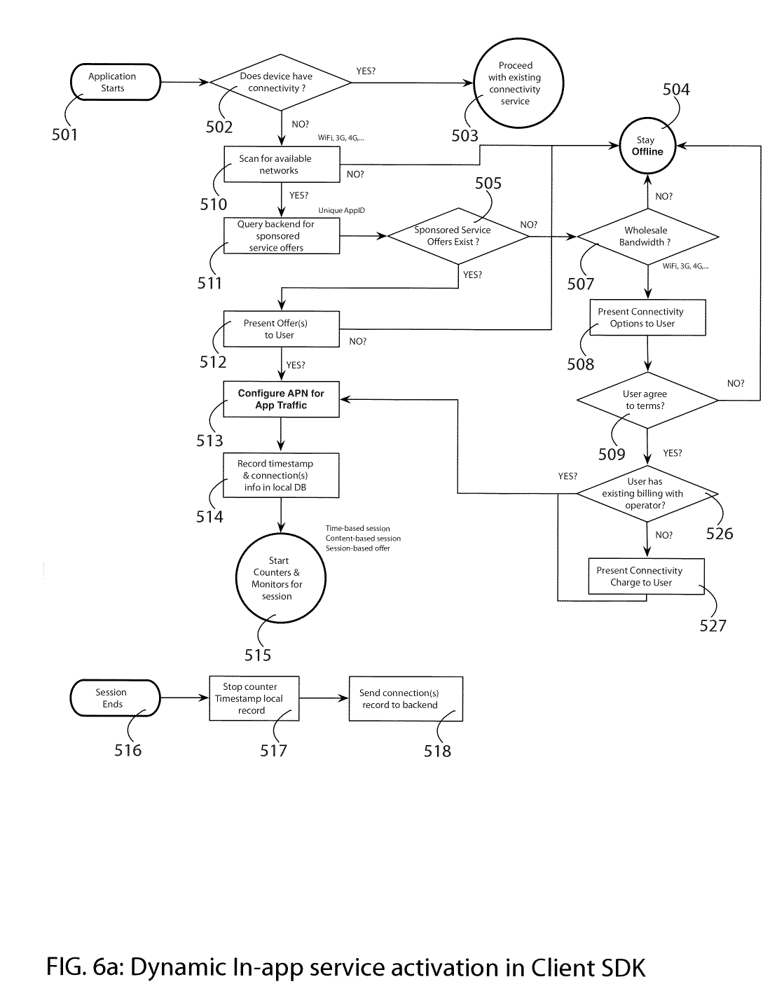

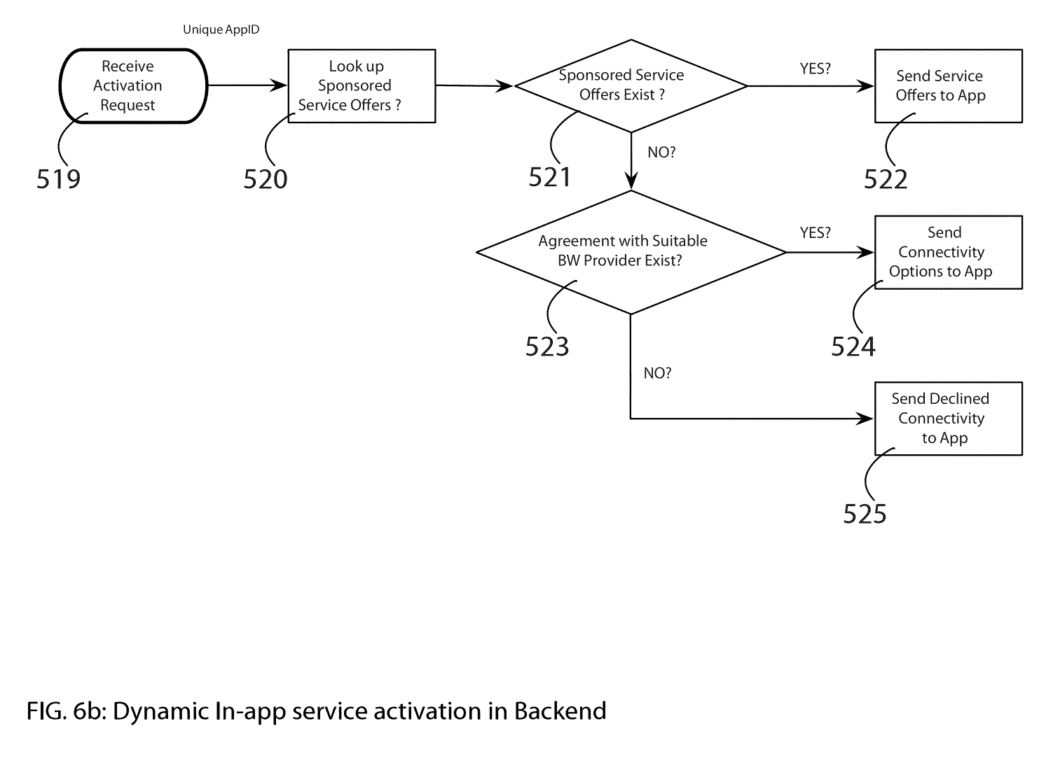

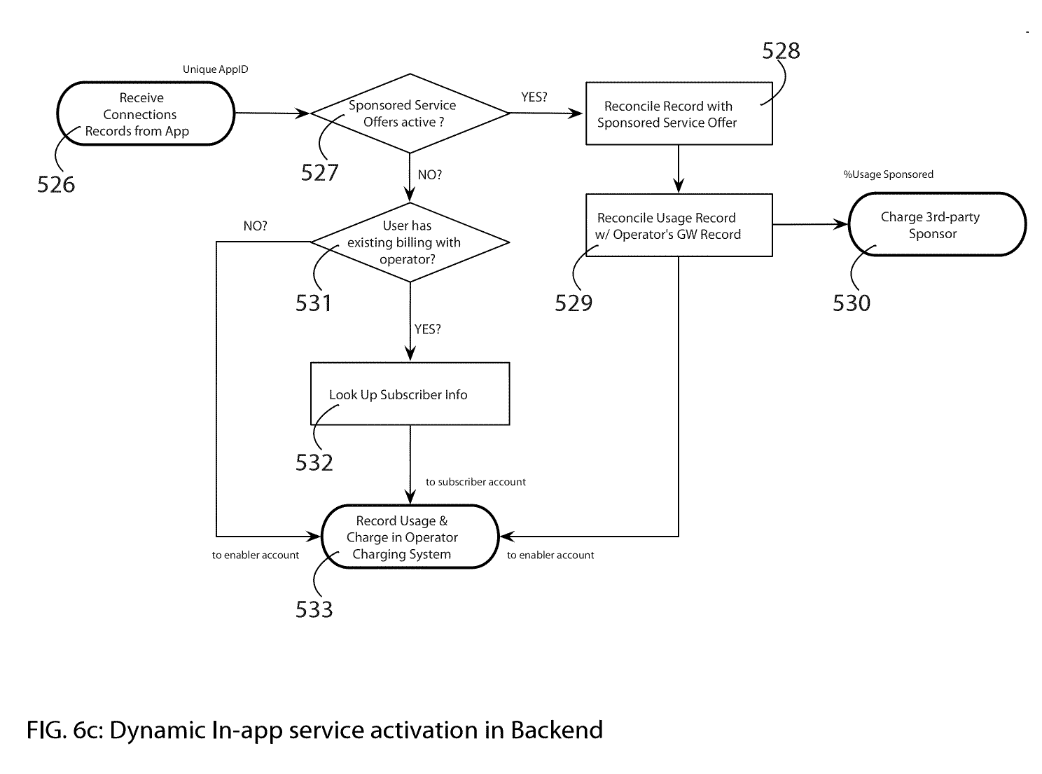

FIG. 6a is a flow diagram describing an in-app service activation process enabled by the client SDK on a mobile device when an application starts.

FIG. 6b is a flow diagram describing an in-app service activation process in a split-billing platform's backend when it receives a dynamic activation request.

FIG. 6c is a flow diagram describing an in-app service activation process in a split-billing platform's backend when it receives connections records from an application.

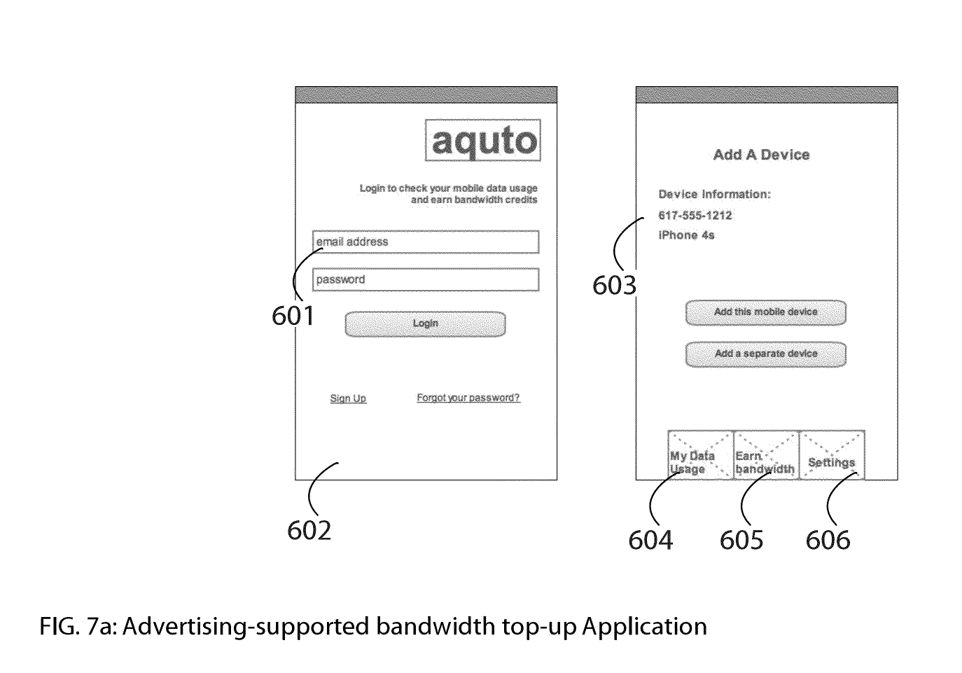

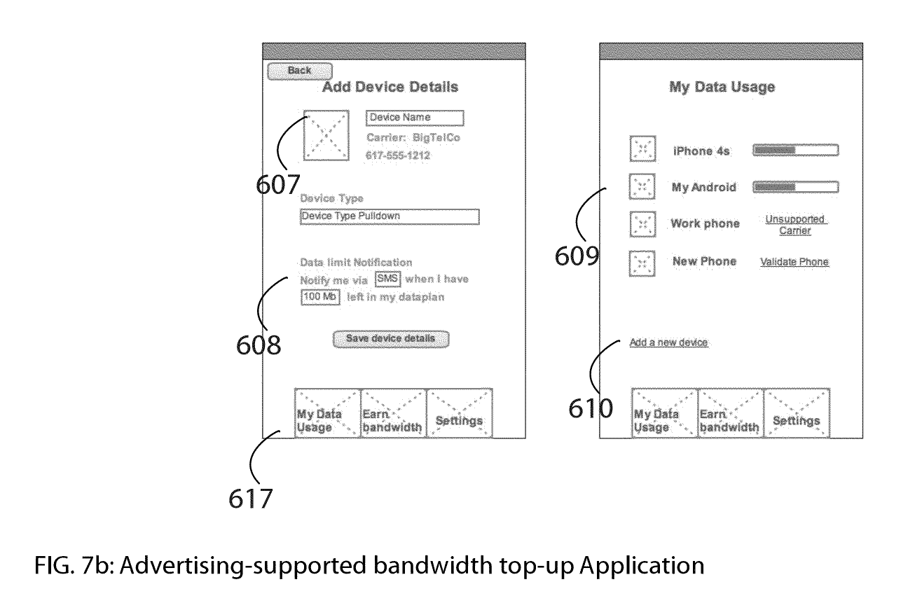

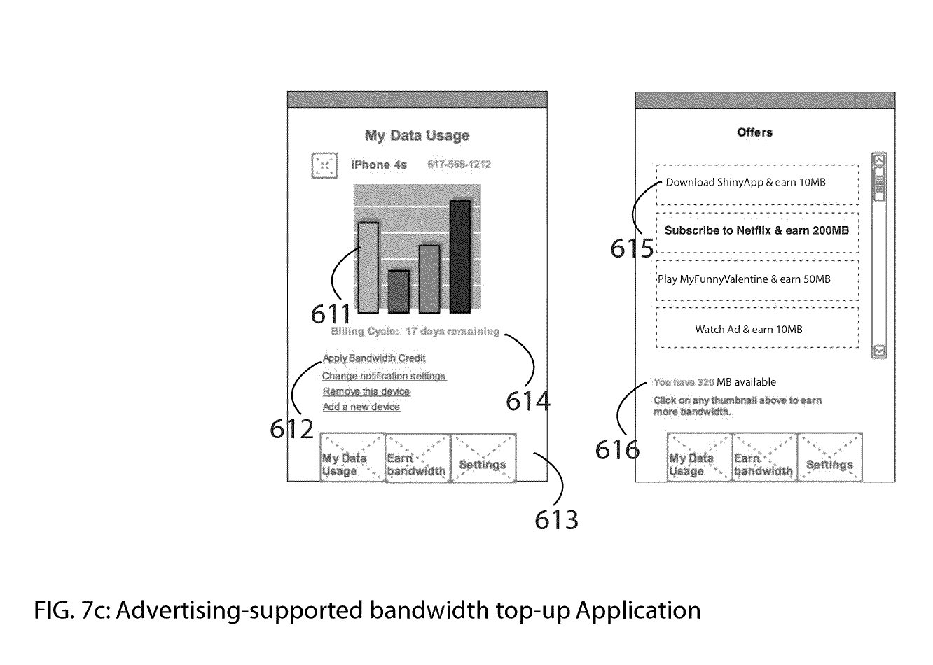

FIGS. 7a, 7b, 7c are wireframe diagrams of an advertising-supported bandwidth top-up application on a mobile device.

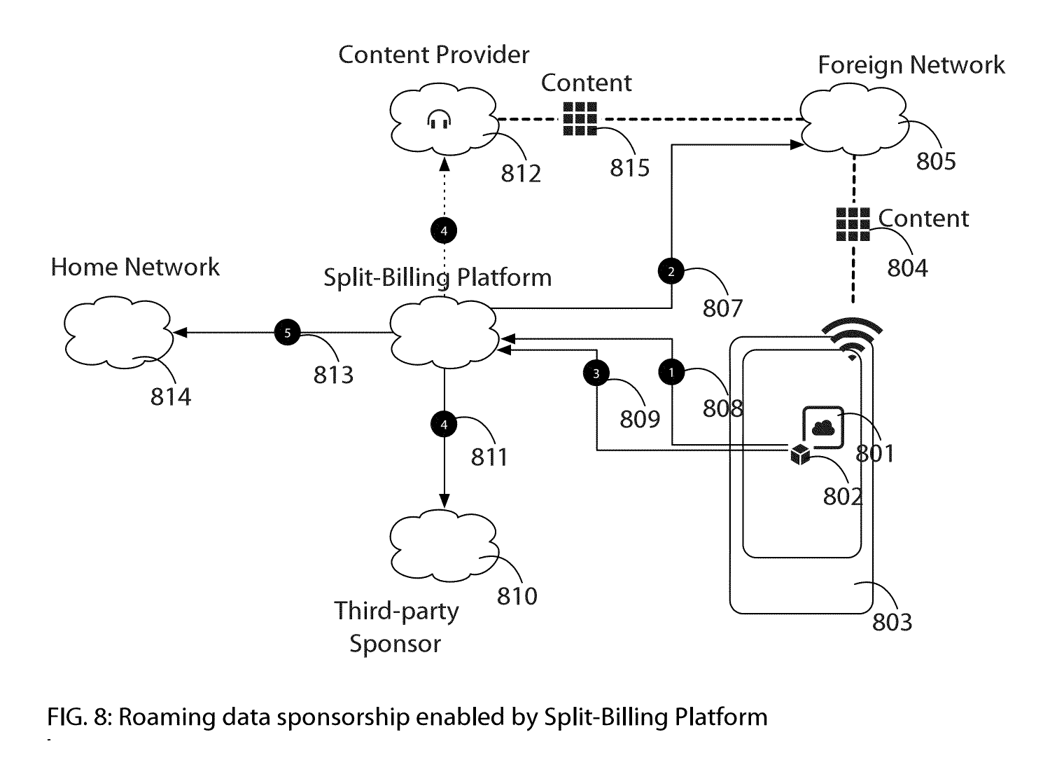

FIG. 8 is a logical flow diagram describing roaming traffic sponsorship enabled by a split-billing platform.

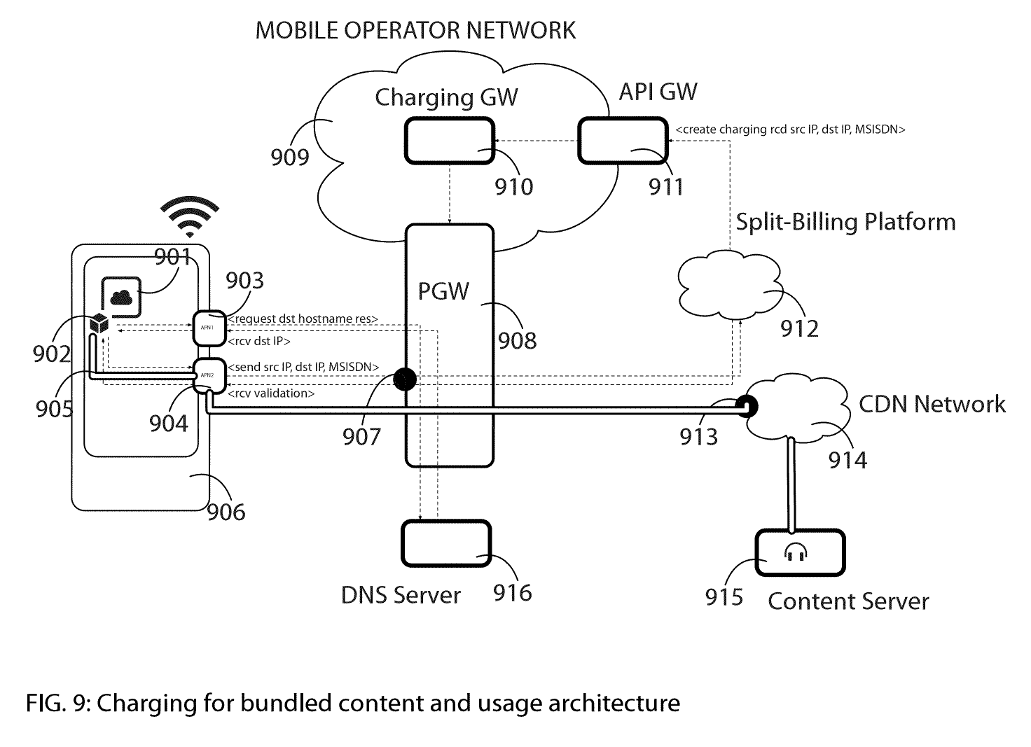

FIG. 9 is a logical functional diagram describing charging for bundled content and usage.

Here we describe a new way to deliver, charge, and bill for applications, content, and services (which we sometimes call simply content) in which the cost of distribution of the content (for example, in connection with a user using or experiencing the content) is included in the charge for the content. In some implementations, the system that we describe here can be characterized as a dynamic, per-content-based multi-party charging and billing platform associated with data delivery in a mobile network. As shown in FIG. 2, in some examples, the platform 200 that we describe here can support any type of content 198 and subscriptions 196 for content that are delivered to or purchased for any kind of device 100, mobile or otherwise, on any network 194, from dozens if not hundreds of content providers 192.

Providing such a platform is a complex endeavor. Millions of mobile devices sold by Apple, for instance, can be provisioned on hundreds of mobile wireless networks worldwide, and the content and communication traffic delivered through those networks (and delivery partners such as content delivery networks (CDNs) and consumed by dedicated mobile applications 101 or through mobile browsers 104 running on the devices, can be provided by hundreds of thousands of content providers.

Additionally, many models exist to monetize the content or communication, including the pricing of the application or content or service, recurring subscriptions, ‘freemium’ delivery based on in-app purchases of virtual goods, or subsidizing access to the content using the revenue from advertising that is also delivered. Dynamically packaging content and distribution in the course of charging and billing can require establishing millions of business arrangements among content providers 192, application developers 190, platform providers 188, content delivery networks 186, ad network providers 184, and network operators 194. Additionally, charging for the distribution can be complex as it can vary based on the delivery medium (for example, 3G/4G or Wi-Fi networks), types of CDNs, and the content served (charging for premium content, higher quality versions, application updates, or with the inclusion of advertising, for example).

In some cases, the platform that we describe here is a scalable, cloud-based transactional platform that provides dynamic and differentiated ‘split billing’ in which the distribution cost, including usage, for distributing any content can be accounted for (we sometimes say charged to) and billed to separate parties (e.g., content distributors, communication supporters, mobile or other network operators, content delivery networks, advertisers, and others) based on any arbitrary business arrangement that any two or more than two of the separate parties involved wish to make.

On one end, the platform 200 may be coupled to the application 102 or website 160 that is serving the content or supporting the communication; on the other end, the platform may be coupled to mobile operator networks 303, content delivery networks, and advertisers, for instance. Significantly this transactional platform enables per-app, per-flow, and content-based granularity, which may include but is not limited to a static device-centric approach.

As shown in FIG. 2, a split-billing platform 200 can serve a large number of mobile devices 100 each of which runs a collection of mobile applications 101. At least some of the mobile applications can be designed to be able to communicate with the split-billing platform.

In some implementations, the applications can include applications 102 that are built using tools and frameworks provided by the mobile device 100 vendor 107 and that include a Software Development Kit (SDK) 103 to communicate with the split-billing platform 200. The SDK 103 is included in the software binary of the mobile application 102 at compilation time to run on the mobile device 100. Examples of such SDK-equipped applications include applications built for the Apple iOS and distributed in the Apple AppStore or applications built for the Android OS and distributed in the Google Play store, for instance.

In some implementations, applications could be constructed to be able to communicate with the split-billing platform using standard-based web technologies and can be executed inside a web browser 104. In this context, a web object 105, linked to the web application, can be used to communicate with the split-billing platform 200. Examples of web technologies used for building the web application running in the web browser 104 are HTML5 and CSS. The web object 105 could be a JavaScript script linked and enabled at run time when the web application is launched and providing abstracted socket-level manipulation to the web application; such functionality could be implemented as a socket.io extension.

In some implementations, an entire operating system running on the mobile device can include an OS SDK 106 that can communicate with the split-billing platform 200. In this scenario, the OS SDK 106 is included when the mobile OS is compiled for the mobile device 100 and prepackaged before distribution or it can be a separate application or software library enhancing the functionalities offered by the base mobile OS. Such an OS based process could serve multiple applications running on the mobile device.

In some implementations, combinations of any two or more of the three types of arrangements mentioned above could be used. In addition, other techniques may be possible to design or configure applications running on any hardware or software platform, mobile or otherwise, so that they can communicate with the split-billing platform with respect to usage, usage limits, quotas, and other subjects related to the use of content in its broadest sense. We use the term applications broadly to include, for example, any program, software, executable, or other device that provides access to a user of a device to content that is delivered from a source of content. We sometimes refer to such applications as split-billing-capable applications.

Regardless of how the mobile device or split-billing-aware applications running on it to communicate with the split billing platform 200, a wide variety of functions can be provided through the SDK (or similar device) for interaction with the split-billing platform. The functionalities can be provided regardless of the mode in which they are provided, e.g., in the app SDK 103, web object 105, or OS SDK 106. (We use the term SDK sometimes to refer to any SDK or similar service associated with a split-billing-aware application running on a user device.)

Among other functions, as shown on FIG. 2b, the SDK can support secure connection 121 and authentication 123 with the split billing platform, granular accounting 125, stamping and recording 127 of each traffic flow 129 (e.g., each connection initiated by the client device to communicate over the Internet) and online/offline reporting 131, as well as, optionally, steering the app data traffic on special routes 133. For instance, a mobile network operator could decide to route sponsored traffic through a special APN gateway 135. In this scenario the SDK would, for example, configure the gateway information in the OS and steer the sponsored traffic through those gateways. FIGS. 3a and 3b show the operations performed by the SDK 103 in more details.

The SDK routines are invoked when the application starts 200; as a first step 201, a timestamp containing information such as time and location is recorded in the local database on the mobile or other device. If the device and SDK are not authenticated 203, an authentication routine is initiated 202 with the split-billing platform, passing a unique AppID generated by the SDK to identify a specific application on a specific device. Following a successful authentication or if the device and SDK are already authenticated, an SDK routine checks that a local profile (typically we use the word local to refer to something that is located at or executed or done at the mobile or other user device) for the application and the device exists in the local database 204. If a local profile is not present, a profile is collected 205.

The profile contains information such as the name and the version of the application, various device-specific information such as the device ID, device model, device capabilities, and location. That profile is then sent securely 206 to the split-billing platform, stamped with the unique AppID identifier specific to the device and the application. Once a local profile is present in the local database, the SDK checks if a special APN is required 210 to send traffic over the mobile network. If a special APN is required, a SDK routine checks that an APN profile is present in the local database 209. If an APN profile is not present, a SDK routine retrieves the appropriate APN profile 207 from the split-billing platform, passing the AppID as identifier. Once an APN profile is present in the local database, a SDK routine applies the APN settings 208 for the traffic generated by the application. Once all initialization procedures have been executed, the SDK waits for new connections to be initiated by the application 211.

Once the application initiates a new connection 212, a SDK routine records the connection information into the local database 213. Information recorded may include a 4-tuple characterizing the data session, that is [source IP, source Port, Destination IP, Destination Port]; it also may include information about the media (for instance audio, video streaming, web traffic, bulk download), the timestamp of the connection, the protocol of the session (for instance, HTTP, RTSP, etc.), location coordinates, and information about the network connectivity (cellular or Wi-Fi, type of cellular connection, 3G/4G, signal strength, etc.) among other things. Subsequently, if a special APN 214 is required, an SDK routine is called to configure the network routing to steer the traffic for that connection over the appropriate APN IP address 216.

Once the APN is configured, a counter routine of the SDK is invoked 215, keeping a real-time count of the traffic transmitted or received for that specific connection. Upon the application closing the connection 219, the traffic counter 218 is stopped and a local timestamp is recorded for that connection in the local database. That connection record is then sent 217 to the split-billing platform along with the unique AppID.

Upon the application stopping 220, a timestamp recording the time and location 221 is sent to the split-billing 222 platform.

The information sent to the split-billing 222 platform is designed to be sufficient to enable a wide variety of billing and split billing functions to be performed and features to be implemented.

In some implementations, the split billing platform 200 is a cloud-based platform in charge of, among other things, reconciling the traffic 220 coming from split-billing aware applications running on as many as millions of devices with the business arrangements regulating the network charging for that traffic that has been agreed upon among the parties involved (application developer, content providers, mobile operators, third-party sponsors, advertisers, for example). By cloud-based platform, we mean, for example, that the software implementing the functionalities of the service runs on a server or set of servers accessible by any device connected to the Internet. The server or servers can be located in a private data center or implemented as a server-side service on top of a virtualized hardware platform, such as Amazon EC2.

In some implementations, the platform 200 includes complex distributed systems 205, 204, 202, 203. Within the platform, methods are exposed by software at a large number of client endpoints 205 to support the operations of the SDKs running in the mobile devices 100. The methods exposed include client authentication 230, application flow reporting 232, and interacting 234 with a business logic repository 204. Implementations of those methods may be as RESTful Application Programming Interfaces (API) over secured HTTP as the application layer protocol.

A good data-interchange format to communicate with RESTful API endpoints could use the JSON protocol. A good way to provide client authentication is to provide an implementation of the OAuth protocol between the device and the split-billing platform.

The application flow reporting routines provided by the SDK allow a record and timestamp associated with a particular flow to be encapsulated and serialized using the JSON protocol and reporting to the split-billing platform by way of an API call, passing a identifier, unique to the mobile application as variable, amongst other parameters of the call.

The business logic repository 204 stores rules 236 governing the business logic associated with the usage charging for use of an individual application, group of applications, or content type, for example. The stored rules are configured by the business parties agreeing to a particular charging split (for instance the content provider and a third-party sponsor, such as an advertiser) using a web-based configuration dashboard 206 and are indexed in the business logic repository 204 using a unique charging identifier 238, which maps 239 the rule to a specific application, specific flows inside an application, or a specific content type used by an application. An example of such a rule and its mapping to a particular application is the following:

For a mobile application such as Pandora, which streams audio and monetizes through serving of ads, a business rule could define that all the data usage associated with serving the ads is billed to the respective advertisers; that 10 hours of audio streaming per month is sponsored by Pandora itself, and that the remaining usage is billed to the mobile subscriber. Each of the application flows inside the Pandora application used to retrieve ads will be accounted for, reported to, and reconciled by the split-billing platform based on the agreed business rules so that it can be billed separately to each advertiser. All the application flows related to the audio streaming portion are accounted, reported to, and reconciled by the split-billing platform based on the agreed business rules so that 10 hours or the total usage, whichever is smaller, is billed to Pandora and the remainder is billed to the mobile subscriber.

Charging identifiers are set up by the operators of the split-billing platform through the configuration dashboard and are communicated to the developer 190 of the mobile application as part of the onboarding process, for example, and are passed as a variable to the API calls 242 made by the split-billing-aware application. By abstracting the business logic using such charging identifiers and by provide a mapping from each identifier to a specific application, the control of the definition of a business logic rule can be decoupled from the software programming done using the SDK, allowing the business logic rules to be updated upon changes in the business arrangement between parties (for instance, between Pandora and the mobile subscriber in the example above), without requiring the application to be updated. For instance, in the example above, Pandora could later decide that it is willing to absorb the cost of the usage associated with ads; in that case, the business rule is updated accordingly on behalf of Pandora. Yet the developer of the mobile Pandora application does not need to make changes in the application or to push an update of the application: instead application flows continue to be reported to the split-billing platform using the previously assigned charging identifier. At the split-billing platform, the reported flows are mapped to the updated business rule to implement the new charging arrangement.

SDKs report granular accounting, stamping and recording of data traffic flows, such that every time a data flow is initiated through the SDK, location and start time is stamped and recorded locally, and traffic is accounted locally on a per byte basis while the flow is active. The accounted traffic is reported by the SDK to a reconciliation and accounting subsystem 203, upon termination of the application, with stop time and location stamped, through the methods exposed by the client endpoints 205. The SDK stores the accounted traffic information locally on the device while the flow is active, compacts flow accounting records and timestamps, serializes the data using the JSON protocol, and calls the API method, essentially sending that record to the subsystem 203.

The reconciliation and accounting subsystem consolidates the traffic recorded for each application, content type, or group of applications and reconciles the data with the usage recorded 250 by the charging gateways 252 of the mobile operator 303 on which the mobile device 205 is provisioned. Interfacing with those charging gateways can be done using a charging API 301, using a charging helper 302, or a by a direct integration with the operators' billing and charging systems 300, or by other devices, or by combinations of any two or more of them.

Upon reconciling the incoming traffic data with the total usage recorded by the charging gateways, the system 203 generates aggregated usage and billing reports 260 for each billing cycle corresponding to the business agreement configured in the business logic repository 204. These usage and billing reports can reconcile usage corresponding to the same charging identifier across multiple devices provisioned on different mobile operator networks. For instance, in the example above, the portion of the usage sponsored by Pandora (which is assigned a unique charging identifier) for all the mobile devices running the split-billing-enabled Pandora application will be consolidated in a usage and billing report generated for Pandora at the end of each billing cycle.

Generated usage and billing reports are used by the third-party billing system 201 to bill content providers 192, advertisers 184, and third-party sponsors 264. The reports can also be used to determine which portion 266 of the recorded usage the mobile operator is responsible for and which portion 268 of the recorded usage one or more third-party entities 264 have sponsored. That information may be used to zero-rate (that is, apply no charge for) the corresponding usage from the subscriber usage report.

FIGS. 5a, 5b and 5c highlight three different integration methods with the mobile operator OSS/BSS (Operational Support Systems/Business Support Systems) to process the charges.

In FIG. 5a, the mobile operator is using a special charging APN for the data used by applications enabled by the split-billing platform. The data used by those applications is effectively routed through different network gateways compared to applications not enabled by the split-billing platform, which are routed to the regular network gateways using the default APN. The split-billing platform generates a reconciled charge record 501, which includes the portion of the usage that is billed to the subscriber, the portion of the usage sponsored by the mobile operator, and the portion of the usage sponsored by one or more third-party entities. Interacting with the mobile operator's OSS/BSS elements is done using a charging helper 502, that is, a piece of software running on a dedicated network server or on a shared network server within the mobile operator's network. The charging helper 502 has interfaces to the subscriber information database 507 and the charging and billing OSS 508.

Upon receipt of the record from the split-billing platform, the charging helper 502 first looks up the subscriber information record 503 in the subscriber information database 507. This is followed by an optional reconciliation step 504, which reconciles the total usage recorded by the split-billing platform with the local total usage recorded by the mobile operator's network gateways for those particular sessions, for that particular subscriber. The charging helper 502 then interacts with the charging and billing OSS 508 to charge the operator's account for the portion of usage sponsored, if any. The charging helper 502 then instructs the charging and billing OSS 508 to charge the subscriber's allotment 506 with the difference of the usage attributable to the subscriber and the sum of the usage sponsored by the mobile and other third-parties, if any, which can be negative, indicating that a replenishing of the subscriber's allotment is required.

In FIG. 5b, the mobile operator has implemented an API GW (gateway) 514, which allows interacting with carrier billing and charging OSS and subscriber information database through SOAP or RESTful API endpoints. The split-billing platform generates a reconciled charge record 501, which includes the portion of the usage that is billed to the subscriber, the portion of the usage sponsored by the mobile operator, and the portion of the usage sponsored by one or more third-party entities. The split-billing platform looks up the subscriber information 510 by initiating an API call to the API GW 514. Upon receiving the subscriber record, it then initiates an API call to the API GW 514 to reconcile its internal usage records with those recorded by the mobile operator's network gateway. Upon successful record reconciliation, the split-billing platform initiates an API call to the API GW 514 to charge the operator's account with the portion of the usage sponsored 512, if any. The split-billing platform then initiates an API call to the API GW 514 to charge the subscriber's allotment 513 with the difference of the usage attributable to the subscriber and the sum of the usage sponsored by the mobile and other third-party, if any, which can be negative, indicating that a replenishing of the subscriber's allotment.

The analytics collection engine 202, as further described in FIG. 2c, tracks granular information, on a per-flow basis, recorded by the SDK in each split-billing-aware application, such as usage information 270, content information 272, session information (origin, destination, length) 274, device information 276, location information 278, and roaming status 280. The analytics collection engine 202 is capable of correlating recorded information across devices and mobile (or other) networks for the same user and report consolidated analytics to all parties involved through a secure web dashboard 206 or authenticated RESTful API endpoints 284.

FIG. 4 describes the sequence flow of a multi-party split-billing-aware application example. In this example of a mobile radio application streaming radio content off the Internet, the business arrangement 401 negotiated between the parties involved and stored in the split-billing platform's business logic repository 403, is as follows: the application developer agrees to sponsor 10 hours of usage per month, and the network operator agrees to sponsor 10% of the total traffic, with the remainder, if any, counted towards the subscriber's data plan. The split-billing platform aggregates all the network usage recorded for all the mobile radio application instances 402 and generates a global accounting report 411 at the end of each billing cycle. That global record is reconciled with the usage recorded by the operators' records 409 and the business arrangement 401 is applied against the global record 411; all data that was not carried over the mobile operator's network is pruned from the records (such as data carried over a Wi-Fi network for instance). The reconciled record 410 is then transmitted to the charging function 404 that charges the application developer for its share 408; that is, in this example, the minimum of the total usage recorded or 10 hours for each of the mobile subscriber's record. The charging function 404 then looks up the associated subscriber's information 406 in its database for each record and zero-rates 405 the portion of the usage sponsored by the application developer and the mobile operator; that is, in this example, 10 percent of the total usage plus 10 hours. Zero-rating means that the usage record is removed from the subscriber's bill and not counted towards their data allotment. The charging function 404 then records the portions of the usage sponsored by the mobile operator in the local record 407 for that mobile operator; that is, in this example, 10 percent of the total usage minus the 10 hours sponsored by the application developer.

The platform enables a wide variety of new service models.

As shown in FIGS. 6a, 6b and 6c, in some implementations, in-application data delivery service can be activated dynamically. Many mobile devices 600, such as smartphones and tablets, include both radios 602 to connect to cellular networks 604 (such as a 3G or 4G networks) and radios 606 to connect to Wi-Fi networks 608. In many countries, either a device is sold by the network operator 610 with a data plan tied to the device or the device is acquired separately and a data plan tied to the device needs to be acquired separately. The device cannot connect to the cellular network without being provisioned on that network and tied to an active data plan.

For Wi-Fi networks, there is also a class of commercial offerings requiring a subscription 614 to connect, such as the Boingo service in many airports, Gogo service in airplanes, FON networks throughout Europe, and many Wi-Fi networks available in hotels. Some devices with cellular capabilities are pre-provisioned and can be activated at any time using a more flexible data plan, such as a month-to-month plan, that is tied to and priced for the entire usage of the device. Many subscribers are not willing to pay for multiple data plans, especially for devices considered to be secondary to their primary device. However, they often consider having the potential future option of connecting to the cellular network worth the extra cost of getting the potential option at the time of purchase. In fact, the majority of iPads sold by Apple have cellular network capabilities, but they are never activated.

In some implementations of the transactional split-billing platform that we describe here, communication service can be activated dynamically, after the device is purchased, and activated only for a particular application or group of applications (or services or content) running on the device, without the need to subscribe to an ongoing data plan to activate that device for usage of all applications that it uses.

For example, even on an unconnected device, one for which there is no ongoing subscription for communication service, a user can launch an app 620, such as a split-billing-aware application, and be automatically connected to the Internet 622 with that application fully operational. The application, when launched, can also be presented in the context of a series of options 624 for the connection, such as connecting to a cellular network versus to a Wi-Fi network 626 (with implications of coverage difference), whether the connectivity should be time-based 628 (e.g. the app can be connected for 2 hours), session-based 630 (e.g., the application can be connected only until a movie streaming is done), or content-based 632 (the application is connected to retrieve only specific content).

The presentation arrangement and the business logic model related to the connectivity options are packaged into the SDK provided to the application developer to enable that kind of advanced connectivity. A wide variety of combinations can be arranged for how and by whom the communication service (we sometimes use the words connectivity and usage interchangeably with the phrase communication service) is paid. The connectivity can be paid for by the application provider 640, the user 642, the provider 644 of the device, a third-party 646 that may wish to sponsor the usage associated with the application, or by an advertiser whose advertising is carried in conjunction with the content, or by any combination of two or more of them.

The transactional platform automatically and transparently enables connectivity on candidate networks (commercial cellular or Wi-Fi networks, for example) based on connectivity restrictions and billing arrangements defined by all parties involved in the provision of the communication service and of the content or application.

FIG. 6a describes the sequence flow of the operations performed by the SDK to enable in-app activation. When the application starts 501, a SDK routine checks that the device has connectivity 502; if the device is connected, the existing connectivity service is used 503 and the application uses it to send and receive data. If the device is not connected, a SDK routine scans for available networks 510 reachable using the device's built-in connectivity options (e.g. Wi-Fi, 3G, 4G radios). If no connectivity options are present, the device stays off-line 504. If connectivity options exist, a SDK routine queries the split-billing platform backend 511, passing the unique AppID of the application and the connectivity options to check if sponsored service offers are available. If a sponsored service offer exists 505 and it is not a wholesale bandwidth offer, the offer is presented to the user 512. If the user declines the offer, the application stays offline 504. If the user agrees with the terms of the sponsored offer (often attached to the completion of an action), a SDK routine configures the appropriate APN to steer the application traffic 513. If the offer is a wholesale bandwidth offer 507, that is, the user will be charged for the data usage, the connectivity offer is presented to the user 508. If the user disagrees with the terms of the offer, the application stays offline 504. If the user agrees to the terms of the offer 509 and the user has an existing billing relationship with the provider of bandwidth 526, a SDK routine configures the appropriate APN to steer the application traffic 513. If a prior billing relationship does not already exist, the user is provided with a series of payment options 527.

Upon validation of the payment option, a SDK routing configures the appropriate APN to steer the application traffic 513.

Once the APN is configured, an SDK routine starts a process to record timestamps and connections information and stores that data in a database local to the SDK 514. The SDK then enters a phase where it starts counters and monitors the session(s) 515. The sponsored offer delineates the terms of the session being sponsored; as mentioned before, the session can be time-based (e.g. the user is allowed to use the application for 30 minutes, after which the connection ends), content-based (e.g. the connection is active until a media object, such as a movie or a song, has been retrieved), or session-based (e.g. the connection is active until a session has terminated, the session could be one of a movie streaming or retrieving mapping information for instance). Upon the session ending 516, a SDK routine stops all counters and timestamp local session records 517, which are then send securely to the split-billing platform's backend for processing 518.

FIG. 6b describes the sequence flow of the operations performed by the split-billing platform's backend to enable in-app activation. Upon receiving an activation request 519 from the SDK inside a mobile app, the split-billing platform performs a lookup of sponsored service offers in its local database doing a reverse looking based on the AppID retrieved. If a sponsored service offer exist 521, it is sent to the mobile app for processing 522. If an offer does not exist, the split-billing platform looks for a suitable agreement with a bandwidth provider 523; if one or more suitable agreements are found, the connectivity options are sent to the mobile app 524. If no suitable agreement is found, the split-billing platform issues a declined connectivity reply 525 to the mobile app.

Upon receiving the connection records from the mobile app 526, tagged with the unique AppID, the split-billing platform verifies that a sponsored service offer is active 527 for that connection record. If it is not, the split-billing platform verifies 531 that the user has an existing billing account with the operator of the network against which the usage was counted. If a billing account exists, the split-billing platform looks up the subscriber information and records the usage in the operators' charging & billing OSS 533. If the user does not have an existing billing account with the operator but elected to pay directly for the usage, the usage is charged to the enabler account, which could be the operator of the split-billing platform. If a sponsored service over is active 527, the split-billing platform reconciles the record with the sponsored service offer 528, that is, determining which party sponsors which portion of the usage. The split-billing platform then reconciles its local usage record with the record of the mobile operator 529, per the metering made by its mobile gateways. The data usage is then assigned to the enabler account in the mobile operator's billing system 533 and the third-party sponsoring the offer is charged 530 by the split-billing platform.

In some implementations of the split-billing transactional platform that we describe here, the roaming traffic of an application used outside of the geography can be sponsored by a third-party entity. Let's consider the following scenario where a subscriber roams outside the coverage zone of its service operator and continued connectivity is provided by a partner operator with which the primary operator has a business agreement with. Roaming is generally seamless and free when a user is roaming within the same country but it is a very expensive add-on service when roaming in a foreign country. Most travelers know to restrict roaming usage to the strict minimum. On modern mobile devices, because the entire device is connected, roaming connectivity cannot be restricted to a single or set of applications and, as a result, every background services, including syncing and social applications constantly connecting to the Internet are refreshed and incur roaming charges. Most users have little to no control over this and, as result, tend to turn off data roaming altogether. The split-billing transactional platform automatically and transparently enables connectivity on foreign network, on a per-application basis, restricting any other usage. Additionally, it makes it possible for content providers, advertisers and application developers to sponsor the usage associated with using the application when connected to a foreign network.

FIG. 8 describes how the split-billing platform enables third-party sponsorship of roaming data usage. When a mobile device 803, running a mobile application 801, is enabled by the split-billing platform SDK 802, operating on a foreign network 805, the SDK 802 first queries 808 the split-billing platform 816 for an available sponsorship offer. If no such offer is present in its business agreement database, the application stays offline. If a sponsorship offers exist, the split-billing platform 816 informs 807 the charging function of the foreign network 805 that the usage for the data connection associated with application 801 is to be charged to the split-billing platform's operator's account. The SDK 802 monitors and records the usage associated with that data session, that is the content 804 sent and received through the foreign network 805, which is then transmitted 809 to the split-billing platform 816, which then bills 811 the third-party sponsor 810 or the content provider 812 depending on which entity is sponsoring the roaming data session. The content provider 812 can define a special content 815 to reduce the roaming usage incurred on the foreign network 805.

In some implementations, payment for the content and the distribution charge can be bundled. For example, when a user buys a music, content, or video service, she has the burden to reconcile her traffic usage (and possible additional distribution cost) associated with her use of the service with the data service plan to which she subscribed for her mobile device on which the service is being used. The service platform that we describe here enables the seamless bundling of the usage and related distribution cost with the service (e.g., content) in a scalable manner, such that the distribution cost is built into the price of the service and the data usage associated with using the service is zero-rated, e.g., not counted against the overall usage allotted to user, per her data plan.

The transactional split-billing platform will allow network operators to bypass selling data plans altogether and monetize network use by bundling it with content service subscriptions.

FIG. 9 describes the logical flow of the split-billing platform to enable application and data services bundling. On a mobile device 906, all data traffic is routed through the default APN as configured by the mobile operator during the PDN (public data network) context initialization. All data traffic routed through the default APN 903 is charged to the subscriber's account. A separate APN 904 is defined during the PDN context initialization to charge for the data usage of an application enabled by the split-billing platform 912. By default, all data traffic routed to the PGW 908 through the special APN 904 is denied absent a rule in the PGW explicitly allowing the data session and charging the data usage associated with that session to a charging account.

When a split-billing enabled application 901 wants to establish a data connection to a content server 915, the PGW 908 needs to have a filter present to allow that data connection and apply the appropriate charging rule to that data usage. The SDK 902 retrieves the domain name of the content server 915 the application 901 is trying to reach. Then, the SDK 902 performs a domain name resolution by sending the destination hostname to a DNS server 916 using the default APN 903. The DNS server 916 responds with a DNS reply to the SDK 902 with a record containing the authoritative IP for the content server 915. Because most content on the Internet is served through a CDN (Content Delivery Network), such as CDN 914, the authoritative IP may optionally be the IP 913 of the CDN 914 serving the content on behalf of the content server 915.

Upon receiving the destination IP, the SDK 902 initiates a session initialization request to the split-billing platform 912 which includes the source IP (the IP address of the mobile device), the destination IP, and the MSISDN of the device, which is obtained from the operating system running on the mobile device 906. The IP address or range of IP addresses 907 exposed by the split-billing platform 912 are whitelisted on the PGW 908, that is, the PGW 908 knows that any traffic bound to those IP addresses 907 is charged to the operator of the split-billing platform 912. Upon receiving the query, the split-billing platform 911 initiates a call to the API GW 911, containing the source IP, destination IP, and MSISDN and asking the charging gateway 910 to create a charging record for that data session, which is then transmitted to the PGW 908. Once the filter is applied by the PGW, the split-billing platform 912 validates the initialization by sending a validation reply to the SDK 902, upon which the application 901 initiates a data session 905 with the content server 915, optionally through the CDN 914.

In some implementations, the platform enables an enterprise to operate with its employees on a bring your own device (BYOD) basis rather than the enterprise buying mobile devices in bulk and lending them to their employees. The buy in bulk and lend model offered the benefits of wholesale pricing on devices and data plans, tight control over corporate assets accessed on the device, higher security and control from corporate IT departments, and inherent compatibility between apps and enterprise systems. As employees have acquired personal devices that have more powerful capabilities than the enterprise-supplied devices, some employees carry both their personal devices and their professional ones.

BYOD policies enable employees to use the devices of their choosing. The personal devices are augmented by special software (from companies such as VMware or Enterproid) to guarantee the security, compatibility, and control over corporate assets accessed by the employees' personal devices outside the enterprise as well as provisioning enterprise-branded applications.

Yet existing BYOD policies create complex billing issues. The enterprise is not able to buy capacity in bulk and benefit from lower rates offered by the network providers and all the usage is blended on the employees' cellular bills. And it is hard to separate the bandwidth consumed by an application used for personal use from the bandwidth consumed by another application for corporate use.

The transactional split-billing platform described here enables granular accounting at the application level or even at the traffic flow level and reconciliation in the back end to remove (zero-rate) work usage from the employees' cellular bill and offer a consolidated bill to enterprises for the usage incurred by their employees for work-related activities.

In some implementations, the platform enables effective advertising-based bandwidth subsidy. For any media form, third-party advertising has been a widely used good arrangement for sponsoring or subsidizing the cost or a portion of the cost of creating or distributing content. For example, many mobile applications or subscriptions to Internet services are offered at a reduced price or even free in exchange for serving ads to their users. Mobile devices such as the Amazon Kindle are sold at a discount in exchange for displaying ads. Some media content (e.g. music, videos, TV shows) or virtual goods can be unlocked by users willing to watch ads. Yet subscribers are responsible for acquiring the bandwidth used by not only the Internet services and online media but also the bandwidth used to serve the online ads.

The transactional split-billing platform described here enables a new ad-based economic model in which data usage by applications or Internet services can be dynamically subsidized by advertising on a per-application basis. It allows an application developer or content provider to augment its advertising model to have third-party advertisers sponsor the cost of delivering specific content or connecting to specific Internet services.

For instance, a mobile TV show application could have third-party advertisers sponsor the data usage incurred by streaming a specific TV show to subscribers over the cellular network. Another example is a streaming podcast application where advertisers could sponsor the bandwidth associated with streaming specific shows.

Advertisers already sponsor bandwidth on the supply side. This system allows the advertisers to sponsor the service based on content type and dynamic cloud-based rules on the demand side. Furthermore, the system empowers subscribers with the flexibility to determine whether they are willing to see more ads for a partially or fully sponsored data usage. Additionally, since the platform is connected to the operator's subscriber information database, it is possible to compare the current usage level of subscribers with their monthly data allotment. A subscriber getting towards the limit of his allotment could be offered more ad-sponsored services to avoid hitting his data quota. The platform also allows content providers to monetize through advertising to sponsor the cost of delivering rich-media ads. That is, the bandwidth usage associated with the delivery of ads is billed to the content providers or the advertisers and only the bandwidth used for the delivery of media is counted towards the subscriber's usage.

Instantiations of the advertisement-based bandwidth subsidy could include a standalone application that presents users with advertising and marketing offers for which they earn data bandwidth upon completion. Another instantiation could be to offer a redemption platform for incentive-based marketers and brands looking at driving engagement and retention which could enable their users to redeem bandwidth credits in exchange for currency earned through engagement offers. An alternative to redeeming bandwidth credits could be to credit the subscriber's bill, in particular, when the bandwidth allotment has not been reached at the end of billing cycle. Examples of incentive-based platforms include American Express, which allows consumers to earn points, which could be redeemed as data bandwidth on mobile devices, or Facebook where users could earn Facebook Credits after completing marketing offers or achieving milestones on the platform or in applications built on top of the platform. Other incentive-based platform driving engagement includes SessionM, Fiksu and TrialPay among others.

An example of a standalone application allowing earning data bandwidth in exchange for completing marketing offers or watching advertisements is described in FIG. 11.

The application 602 includes an authentication screen where a user logs in to the application by entering an email address and a password in an authentication field 601. The application 602 also includes a device registration screen 603 allowing to register a mobile device using its mobile number provisioned on a mobile operator's network. The application 602 includes a device information screen 617 allowing the user to configure details about the device, including setting up an avatar 607 and data limit notifications 608 to trigger notifications when usage goes over some threshold. The application 602 includes a data usage summary screen 613, presenting the user with a data usage summary for the selected device, showing a histogram of usage history 611, an indicator of the billing cycle expiration date 614, and a selector widget to apply bandwidth credits 612 to the data service associated with the mobile device.

The techniques and described here can be implemented in digital electronic circuitry, or in computer hardware, firmware, software, or in combinations of them. The techniques can be implemented as computer program products, i.e., computer programs tangibly embodied in information carriers, e.g., in machine-readable storage devices or in propagated signals, for execution by, or to control the operation of, data processing apparatus, e.g., programmable processors, computers, handheld devices, or multiple computers. The computer programs can be written in any form of programming language, including compiled or interpreted languages, and can be deployed in any form, including as stand-alone programs or as a modules, components, subroutines, or other units suitable for use in a computing environment. The computer programs can be deployed to be executed on one computer or device or on multiple computers or devices at one site or distributed across multiple sites and interconnected by communication networks.

Method steps of the techniques described herein can be performed by one or more programmable processors executing a computer program to perform functions by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer can include a processor for executing instructions and one or more memory devices for storing instructions and data. Generally, a computer (when we use the term computer we are also referring to mobile devices, for example) will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described here can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, cellular and mobile networks, Wi-Fi, and others, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other implementations are also within the scope of the following claims.

1. A computer-implemented method comprising
at a server, receiving information from applications, services, or content being used on user devices about usage of communication services attributable to each of the applications, services, or content, and
using the information about the amounts of attributable communication services in allocating charges for the services to one or more paying parties in accordance with one or more applicable business rules.

2. The method of claim 1 in which the usage information is expressed at a granularity that can be at least as fine-grained as per application, per service, or per item of content.

3. The method of claim 1 in which the devices comprise mobile devices.

4. The method of claim 1 in which the devices comprise non-mobile devices.

5. The method of claim 1 in which the paying parties include at least one of: communication service providers, advertisers, end users, network operators, content delivery network operators, content providers, application providers, or service providers.

6. The method of claim 1 in which the charges are shared between at least two different paying parties.

7. The method of claim 1 in which the information about usage of communication services comprises information about at least one of: time period of use, instances of use, or bandwidth of use.

8. The method of claim 1 in which the business rules comprise rules agreed upon by at least one of the paying parties.

9. The method of claim 1 in which the business rules comprise bundling the charges for communication services with charges for applications, services, or content.

10. The method of claim 1 in which the business rules can be changed dynamically without changing processes running on the user devices from which the usage information is received.

11. The method of claim 1 in which the usage information comprises information with respect to at least one of usage, usage limits, or quotas.

12. A computer-implemented method comprising
at a user device, tracking a usage of communication service that is attributable to the use of an application, service, or content on the device, and
sending the tracked amount of communication service to a server for use in allocating charges for the services to one or more paying parties in accordance with one or more applicable business rules.

13. The method of claim 12 in which the tracked usage is expressed at a granularity that can be at least as fine-grained as per application, per service, or per item of content.

14. The method of claim 12 in which the devices comprise mobile devices.

15. The method of claim 12 in which the devices comprise non-mobile devices.

16. The method of claim 12 in which the paying parties include at least one of: communication service providers, advertisers, end users, network operators, content delivery network operators, content providers, application providers, or service providers.

17. The method of claim 12 in which the charges are shared between at least two different paying parties.

18. The method of claim 12 in which the tracked usage of communication services comprises information about at least one of: time period of use, instances of use, or bandwidth of use.

19. The method of claim 12 in which the business rules comprise rules agreed upon by at least one of the paying parties.

20. The method of claim 12 in which the business rules comprise bundling the charges for communication services with charges for applications, services, or content.

21. The method of claim 12 in which the business rules can be changed dynamically without changing processes running on the user devices from which the usage information is received.

22. The method of claim 12 in which the tracked usage comprises information with respect to at least one of usage, usage limits, or quotas.

23. The method of claim 12 in which the usage is tracked by at least one of: a process that is included in a software binary of the application, service, or content; a process executed within a Web browser; or a process running as part of an operating system

24. The method of claim 12 in which tracking of usage can include at least one of the following functions: secure connection, authentication, granular accounting, stamping and recording of each connection initiated by the device to use communication services, offline reporting, or steering of communication traffic.

25. A system comprising
processes running on user devices that track usage of communication services attributable to use of applications, services, or content on the devices, and
an allocation process running on a server that uses the tracked usage information in allocating charges for the communication services to paying parties based on one or more applicable business rules.

26. The method of claim 12 in which the tracked usage is expressed at a granularity that can be at least as fine-grained as per application, per service, or per item of content.

27. The method of claim 12 in which the devices comprise mobile devices.

28. The method of claim 12 in which the devices comprise non-mobile devices.

29. The method of claim 12 in which the paying parties include at least one of: communication service providers, advertisers, end users, network operators, content delivery network operators, content providers, application providers, or service providers.

30. The method of claim 12 in which the charges are shared between at least two different paying parties.

31. The method of claim 12 in which the tracked usage of communication services comprises information about at least one of: time period of use, instances of use, or bandwidth of use.

32. The method of claim 12 in which the business rules comprise rules agreed upon by at least one of the paying parties.

33. The method of claim 12 in which the business rules comprise bundling the charges for communication services with charges for applications, services, or content.

34. The method of claim 12 in which the business rules can be changed dynamically without changing processes running on the user devices from which the usage information is received.

35. The method of claim 12 in which the tracked usage comprises information with respect to at least one of usage, usage limits, or quotas.

36. The method of claim 12 in which the usage is tracked by at least one of: a process that is included in a software binary of the application, service, or content; a process executed within a Web browser; or a process running as part of an operating system

37. The method of claim 12 in which tracking of usage can include at least one of the following functions: secure connection, authentication, granular accounting, stamping and recording of each connection initiated by the device to use communication services, offline reporting, or steering of communication traffic.

38. An apparatus comprising
an executable program stored on a user device that, when running on the user device, tracks usage of communication services attributable to applications, services, or content being used on the device and reports the tracked usage to a server for use in allocating charges for the communication services to paying parties based on one or more applicable business rules.

39. The method of claim 38 in which the tracked usage is expressed at a granularity that can be at least as fine-grained as per application, per service, or per item of content.

40. The method of claim 38 in which the devices comprise mobile devices.

41. The method of claim 38 in which the devices comprise non-mobile devices.

42. The method of claim 38 in which the paying parties include at least one of: communication service providers, advertisers, end users, network operators, content delivery network operators, content providers, application providers, or service providers.

43. The method of claim 38 in which the charges are shared between at least two different paying parties.

44. The method of claim 38 in which the tracked usage of communication services comprises information about at least one of: time period of use, instances of use, or bandwidth of use.

45. The method of claim 38 in which the business rules comprise rules agreed upon by at least one of the paying parties.

46. The method of claim 38 in which the business rules comprise bundling the charges for communication services with charges for applications, services, or content.

47. The method of claim 38 in which the business rules can be changed dynamically without changing processes running on the user devices from which the usage information is received.

48. The method of claim 38 in which the tracked usage comprises information with respect to at least one of usage, usage limits, or quotas.

49. The method of claim 38 in which the usage is tracked by at least one of: a process that is included in a software binary of the application, service, or content; a process executed within a Web browser; or a process running as part of an operating system

50. The method of claim 38 in which tracking of usage can include at least one of the following functions: secure connection, authentication, granular accounting, stamping and recording of each connection initiated by the device to use communication services, offline reporting, or steering of communication traffic.

51. An apparatus comprising
an executable program stored on a server that, when running on the server, receives from user devices, information about usage of communication services attributable to applications, services, or content being used on the devices and allocates charges for the communication services to paying parties based on one or more applicable business rules.

52. The method of claim 51 in which the tracked usage is expressed at a granularity that can be at least as fine-grained as per application, per service, or per item of content.

53. The method of claim 51 in which the devices comprise mobile devices.

54. The method of claim 51 in which the devices comprise non-mobile devices.

55. The method of claim 51 in which the paying parties include at least one of: communication service providers, advertisers, end users, network operators, content delivery network operators, content providers, application providers, or service providers.

56. The method of claim 51 in which the charges are shared between at least two different paying parties.

57. The method of claim 51 in which the tracked usage of communication services comprises information about at least one of: time period of use, instances of use, or bandwidth of use.

58. The method of claim 51 in which the business rules comprise rules agreed upon by at least one of the paying parties.

59. The method of claim 51 in which the business rules comprise bundling the charges for communication services with charges for applications, services, or content.

60. The method of claim 51 in which the business rules can be changed dynamically without changing processes running on the user devices from which the usage information is received.

61. The method of claim 51 in which the tracked usage comprises information with respect to at least one of usage, usage limits, or quotas.

62. The method of claim 51 in which the usage is tracked by at least one of: a process that is included in a software binary of the application, service, or content; a process executed within a Web browser; or a process running as part of an operating system

63. The method of claim 51 in which tracking of usage can include at least one of the following functions: secure connection, authentication, granular accounting, stamping and recording of each connection initiated by the device to use communication services, offline reporting, or steering of communication traffic.

64. A computer-implemented method comprising
determining charges for communication services that are attributable to applications, services, or content used on mobile devices that are subject to communication service agreements between a provider of the communication services and customers, and
interacting with a system of the provider of the communication services to cause records associated with the customers to reflect at least portions of the charges that are to be paid by someone other than the customers.

65. The method of claim 64 in which the charges are to be paid by the provider of the communication services.

66. The method of claim 64 in which the charges are to be paid by a third party.

67. The method of claim 64 in which the system of the provider comprises a billing system.

68. The method of claim 64 in which the interacting with the system of the provider is done using an APN.

69. The method of claim 68 in which the interacting with the system of the provider comprises use of a special charging APN for the applications, services, or content.

70. The method of claim 64 in which the interacting includes providing to the system of the provider charge records that include portions of the communication services usage that are to be billed to the customers, portions that are to be sponsored by the communication services provider, and portions that are to be sponsored by third parties.

71. The method of claim 64 in which the communication service providers include mobile operators.

72. The method of claim 68 in which the interacting with the system of the provider comprises use of a regular APN and a charging API.

73. The method of claim 68 in which the interacting with the system of the provider comprises use of a regular APN and offline record reconciliation between records that reflect the determined charges and communication service usage recorded by network gateways.

74. A computer-implemented method comprising
at a user device that is to receive communication services under a subscription agreement and on which applications, services, or content are to be used for which communication services are to be charged at least in part to someone other than a subscriber under the subscription agreement,
causing communication for the applications, services, or content to be carried through a special communication gateway that is maintained by a provider of the communication services.

75. The method of claim 74 in which the communications are caused to be carried through the special gateway on a per-application, per-service, or per-content item basis.

76. The method of claim 74 in which the communications are caused to be carried through the special gateway on a per-flow basis.

77. The method of claim 74 in which the gateway is associated with a special access point name (APN).

78. The method of claim 77 in which different APNs are used simultaneously for different applications, services, or items of content, or within a given application, service, or item of content.

79. The method of claim 74 in which causing the communication to be carried through a special communication gateway comprises running a process on the user device that selectively sends the communications for the applications, services, or content to the gateway and sends other communications through another communication gateway.

80. The method of claim 79 in which the communications are sent to an appropriate gateway using appropriate an appropriate APN.

81. The method of claim 74 in which the provider of communication services comprises a mobile operator and the device comprises a mobile device.

82. A computer-implemented method comprising
operating a gateway of a communication service provider to receive specially directed communications from user devices, the specially directed communications being attributable to applications, services, or content for which communication services are to be charged at least in part to someone other than a subscriber of the communication services provider.

83. The method of claim 82 in which the gateway is associated with a special access point name (APN).

84. The method of claim 83 in which different APNs are used simultaneously for different applications, services, or items of content, or within a given application, service, or item of content.

85. The method of claim 82 comprising processing charges for the specially directed communications in accordance with agreements of sponsors of the specially directed communications.

86. The method of claim 82 in which the provider of communication services comprises a mobile operator and the devices comprise mobile devices.

87. The method of claim 82 in which the specially directed communications are received on a per-application, per-service, or per-content item basis.

88. The method of claim 82 in which the specially directed communications are received on a per-flow basis.

89. A computer-implemented method comprising
at a user device, in connection with the use of a particular application, service, or item of content or a set of applications, services, or items of content, enabling a user to select a communication service arrangement to be used for that particular application, service, or item of content, or set of applications, services, or items of content.

90. The method of claim 89 in which the selection is enabled at the time of initiation of use of the particular application, service, or item of content or set of applications, services, or items of content.

91. The method of claim 89 in which the user device comprises a mobile device.

92. The method of claim 89 in which the communication service arrangement comprises one of two or more available service arrangements that have different bandwidth or coverages or both.

93. The method of claim 92 in which the service arrangements comprise cellular telephone network service or Wi-Fi service.

94. The method of claim 89 in which the service arrangements comprise at least one of time-based arrangements, session-based arrangements, or content-based arrangements.

95. The method of claim 89 in which the selection is enabled by a process running on the user device.

96. The method of claim 95 in which the process is configured to enable the selection based on a predetermined business model.

97. A computer-implemented method comprising
for a mobile device for which a subscription agreement is applicable for a covered area and for which roaming charges apply outside of the covered area,
enabling a user of the mobile device to (a) selectively control operation of the mobile device so that roaming charges will not apply to any use of the mobile device, and (b) while the roaming charges are not applied, use one or more individual applications, services, or items of content on the mobile device that require communication services, and to have the communication services paid for with respect to the use of the one or more individual applications, services, or items of content.

98. The method of claim 97 in which the communication services are paid for by at least one of a provider of the application, service, or item of content, an advertiser, or a developer of the application, service, or item of content.

99. The method of claim 97 in which the user is enabled to have the communication services paid for by a process that runs on the mobile device, tracks the communication services that are used, and reports them to a server.

100. A computer-implemented method comprising
for a mobile device used by a person in at least two different contexts such that the communication service charges for uses in the two different contexts are to be charged to two or more different corresponding parties based on different applications, services, items of content, or traffic flows that are attributable to uses in the different contexts,
tracking communication service usage on the mobile device for the different applications, services, items of content, or traffic flows, and
using the tracked usage to charge the corresponding parties for usage in the different contexts.

101. The method of claim 100 in which the two different contexts comprise personal activities and work activities.

102. The method of claim 100 in which the user is one of the parties to be charged and an employer or other entity with which the user has a relationship is another one of the parties to be charged.

103. The method of claim 100 in which there are multiple mobile devices and charges for uses in one of the contexts by the users of the mobile devices are consolidated for billing to an entity with which all of the users have a relationship.

104. The method of claim 100 in which the users are all employees of the entity and the contexts are personal use and work use.

105. A computer-implemented method comprising
enabling a user of a user device to receive value in exchange for permitting an advertising or marketing communication to be presented on the device in connection with the user making use of a particular application, service, or item of content on the user device.

106. The method of claim 105 in which the user device comprises a mobile device.

107. The method of claim 105 in which the value comprises a right to use an amount of communication bandwidth.

108. The method of claim 107 in which the communication bandwidth value can be redeemed on another user device of the user.

109. The method of claim 108 in which the user device and the other user device are provisioned on networks of different communication carriers.

110. The method of claim 105 in which the timing of the ability to exchange value or the amount of value to be received vary with an amount of subsidized communication service remaining available for the user.

111. The method of claim 105 comprising enabling the user to redeem the value in exchange for currency earned through engagement offers of marketers or brand owners.

112. The method of claim 105 in which the value comprises a right to use a particular item of content in exchange for watching an advertisement.

113. A computer-implemented method comprising
delivering advertising to a user device in connection with a use on the device of an application, service, or item of content, the user device being associated with a subscription agreement for communication services, and
arranging for a portion of the communication services that are attributable to the application, service, or item of content to be zero-rated with respect to billing under the subscription agreement.

114. The method of claim 113 in which the user device comprises a mobile device.

115. The method of claim 113 in which the zero-rating is arranged on a per-application, per-service, per-item of content or per-traffic flow basis.

116. A computer-implemented method comprising
receiving information about amounts of communication services attributable to respective uses of applications, services, or items of content on two or more user devices that are subject to subscription agreements for communication services with a single party, and
correlating the information across the two or more user devices.

117. The method of claim 116 in which the two or more user devices are provisioned on two or more different communication service networks.

118. The method of claim 116 in which the user devices comprise mobile devices.
